(19) United States
(12) Patent Application Publication
(10) Pub. No.: US 2018/0239524 A1
(43) Pub. Date: Aug. 23, 2018

(54) METHODS AND DEVICES FOR PROVIDING EFFECTS FOR MEDIA CONTENT

(71) Applicant: Facebook, Inc., Menlo Park, CA (US)

(72) Inventors: Scott Snibbe, San Francisco, CA (US); Johan Ismael, Menlo Park, CA (US)

(21) Appl. No.: 15/961,468

(22) Filed: Apr. 24, 2018

Related U.S. Application Data
(60) Provisional application No. 62/533,613, filed on Jul. 17, 2017.
(60) Provisional application No. 62/533,615, filed on Jul. 17, 2017.

(51) Int. Cl. G06F 3/0484; G11B 27/031

(52) U.S. Cl. CPC G06F 3/04847; G11B 27/031

(57) ABSTRACT

The various implementations described herein include methods, devices, and systems for providing and editing audiovisual effects. In one aspect, a method is performed at a first device having one or more processors and memory. The method includes: (1) presenting a user interface for effects development, including a specification for an effect in development; (2) displaying on a display device the effect applied to a video stream; (3) while displaying the effect applied to the video stream, receiving within the user interface one or more updates to the specification; (4) compiling the updated specification in real-time; and (5) displaying on the display device an updated effect applied to the video stream, the updated effect corresponding to the updated specification.

### RELATED APPLICATIONS

This application claims priority under 35 U.S.C. § 119(e) to U.S. Provisional Patent Application No. 62/533,613, entitled “Methods and Devices for Providing Effects for Media Content,” and U.S. Provisional Patent Application No. 62/533,615, entitled “Methods and Devices for Providing Interactive Effects,” both filed on Jul. 17, 2017. The disclosures of the 62/533,613 and 62/533,615 applications are herein incorporated by reference in their entirety. This application is related to U.S. patent application Ser. No. 14/608,103 (issued as U.S. Pat. No. 9,207,857), filed Jan. 28, 2015, entitled, “Methods and Devices for Presenting Interactive Media Items,” the disclosure of which is also hereby incorporated by reference in its entirety.

### TECHNICAL FIELD

The disclosed implementations relate generally to audiovisual effects for media items, including, but not limited, to real-time effect development and mapping of effects to various electronic devices.

### BACKGROUND

As wireless networks and the processing power of mobile devices have improved, applications increasingly allow everyday users to create original content in real-time without professional software. For example, Instagram allows a user to create original media content. Despite the advances in the provision of media creation applications, solutions for creating media content are clumsy or ill-suited to future improvements in provisioning media content. In addition, users creating personalized media content often wish to add audio and/or visual effects to the media content. Those users prefer increasingly more intricate and/or customized effects.

### SUMMARY

Accordingly, there is a need for more intuitive, effective, and efficient means for developing, applying, and distributing effects for media content. Various implementations of systems, methods and devices within the scope of the appended claims each have several aspects, no single one of which is solely responsible for the attributes described herein. Without limiting the scope of the appended claims, after considering this disclosure, and particularly after considering the section entitled “Detailed Description” one will understand how the aspects of various implementations are used to present interactive media items.

In some implementations, a first method of developing effects is performed at a client device (e.g., client device 104, FIG. 1) with one or more processors and memory. The first method includes: (1) presenting a user interface for effects development, including a specification for an effect in development; (2) displaying on a display device the effect applied to a video stream; (3) while displaying the effect applied to the video stream, receiving within the user interface one or more updates to the specification; (4) compiling the updated specification in real-time; and (5) displaying on the display device an updated effect applied to the video stream, the updated effect corresponding to the updated specification.

One hurdle with developing interactive effects for media items is that users playback media items on a wide range of electronic devices (e.g., desktops, tablets, mobile phones, etc.). When applying an effect to a media item, it is generally desirable for the effect to operate in a same or similar manner on each electronic device. For example, a user generally desires to be able to interact with the effect on a tablet in a similar manner as the user interacts with the effect on a laptop computer. Therefore, in some instances, the input parameters that make the effect interactive should map to a diverse set of electronic devices in such a manner that the interactivity is intuitive to a user.

Accordingly, in some implementations, a second method of developing effects is performed at a client device (e.g., client device 104, FIG. 1) with one or more processors and memory. The second method includes: (1) receiving executable instructions for an interactive effect from a second electronic device, the executable instructions having one or more input parameters, where one or more user-discernable features of the interactive effect vary based on data from the one or more input parameters; (2) mapping the one or more input parameters to one or more device inputs of the client device; (3) applying the interactive effect to a video stream (e.g., a live or stored stream); (4) receiving data from at least one of the one or more device inputs; and (5) adjusting one or more user-discernable features of the interactive effect based on the received data.

In some implementations, an electronic device (e.g., client device 104, FIG. 1) includes one or more processors and memory storing one or more programs for execution by the one or more processors, the one or more programs including instructions for performing the operations of any of the methods described herein. In some implementations, a non-transitory computer-readable storage medium storing one or more programs, the one or more programs comprising instructions, which, when executed by an electronic device (e.g., client device 104, FIG. 1) with one or more processors, cause the electronic device to perform the operations of any of the methods described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a block diagram of a server-client environment in accordance with some implementations.

FIG. 2A is a block diagram of a computer system in accordance with some implementations.

FIG. 2B is a block diagram of a client device in accordance with some implementations.

FIG. 3 is a block diagram of a server system in accordance with some implementations.

FIGS. 4A-4H illustrate representative user interfaces for developing media item effects in accordance with some implementations.

FIGS. 5A-5G illustrate representative user interfaces for presenting interactive media items in accordance with some implementations.

FIG. 6 is a diagram of a representative metadata structure for a respective media item in accordance with some implementations.

FIG. 7 illustrates a flowchart representation of a method of developing media item effects in accordance with some implementations.

FIG. 8A is a block diagram illustrating representative effect parameters within an effect specification in accordance with some implementations.

FIGS. 8B-8E illustrate prophetic mappings of effect parameters to device inputs in accordance with some implementations.

FIG. 9 illustrates a flowchart representation of a method of providing interactive effects in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals are used to denote like features throughout the specification and figures.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

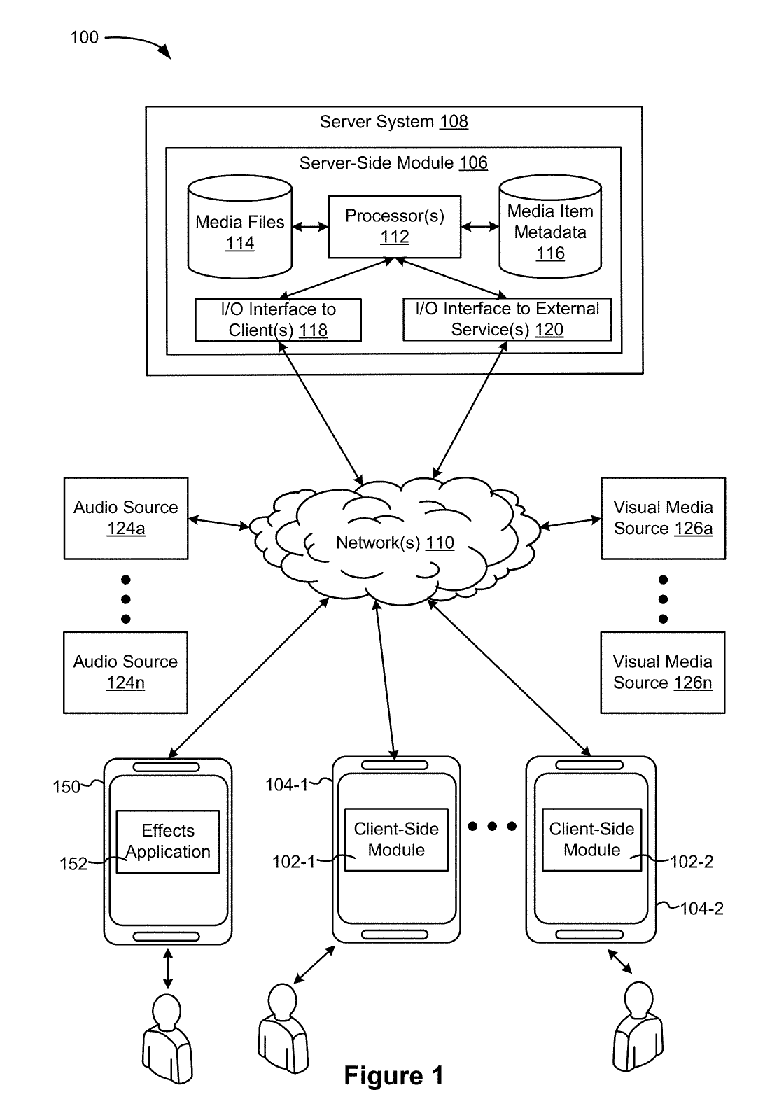

As shown in FIG. 1, server- and client-side modules for generating, exploring, and presenting media items are implemented in a server-client environment 100 in accordance with some implementations. In some implementations, the client-side processing modules 102-1, 102-2 (hereinafter “client-side module 102”) are executed on client devices 104-1, 104-2 and the server-side processing modules 106 (hereinafter “server-side module 106”) are executed on a server system 108. In some implementations, a client-side module 102 communicates with a server-side module 106 through one or more networks 110. The client-side module 102 provides client-side functionalities, such as client-facing input and output processing (e.g., for the creation and presentation of media items) and communications with server-side module 106. The server-side module 106 provides server-side functionalities (e.g., generating metadata structures for, storing portions of, and causing/directing presentation of media items) for any number of client modules 102 each residing on a respective client device 104.

In some implementations, the server-client environment 100 includes an effects development application 152 executed on a computer device 150. In some implementations, the effects development application 152 is employed by a software developer to generate and/or update interactive effects. In some implementations, the interactive effects are configured to be applied to video streams or media items developed and/or presented within the client-side modules 102. In some implementations, the effects development application 152 is implemented in one or more of the client-side modules 102 that execute on the client devices 104. In some implementations, the computer device 150 is a computer system that is distinct from one of the client devices 104. In some implementations, the computer device 150 is a client device 104.

In some implementations, the server-side module 106 includes one or more processors 112, a media files database 114, a media item metadata database 116, an I/O interface to one or more clients 118, and an I/O interface to one or more external services 120. I/O interface to one or more clients 118 facilitates the client-facing input and output processing for server-side module 106. One or more processors 112 receive requests from the client-side module 102 to create media items or obtain media items for presentation. The media files database 114 stores audio, visual, and/or audiovisual media files, such as images, video clips, and/or audio tracks, associated with media items, and the media item metadata database 116 stores a metadata structure for each media item, where each metadata structure associates one or more visual media files and one or more audio files with a media item. In some implementations, the media files database 114 stores audio, visual, and/or audiovisual effects for media items. In various implementations, a media item is a visual media item, an audio media item, or an audiovisual media item.

In some implementations, the media files database 114 and the media item metadata database 116 compose a single database. In some implementations, the media files database 114 and the media item metadata database 116 are communicatively coupled with, but located remotely from, server system 116. In some implementations, media files database 114 and media item metadata database 116 are located separately from one another. In some implementations, server-side module 106 communicates with one or more external services such as audio sources 124a . . . 124n and media file sources 126a . . . 126n through one or more networks 110. I/O interface to one or more external services 120 facilitates such communications.

Examples of a client device 104 and/or computer system 150 include, but are not limited to, a handheld computer, a wearable computing device, a biologically implanted computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices.

Examples of one or more networks 110 include local area networks (“LAN”) and wide area networks (“WAN”) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 108 is implemented on one or more standalone data processing apparatuses or a distributed network of computers. In some implementations, the server system 108 also employs various virtual devices and/or services of third party service providers (e.g., third-party cloud service providers) to provide the underlying computing resources and/or infrastructure resources of server system 108.

Although the server-client environment 100 shown in FIG. 1 includes both the client-side modules 102 and the server-side module 106, in some implementations, the methods described herein are performed at a client device 104. In addition, the division of functionalities between the client and server modules varies in different implementations. For example, in some implementations, the client-side module 102 is a thin-client that provides only user-facing input and output processing functions, and delegates all other data processing functionalities to a backend server (e.g., server system 108). Similarly, in some implementations, the effects application 152 is executed at the computer system 150. In some implementations, the effects application 152 includes functionalities performed at the server system 108, functionalities performed at the computer system 150, and/or functionalities performed at the client device(s) 104.

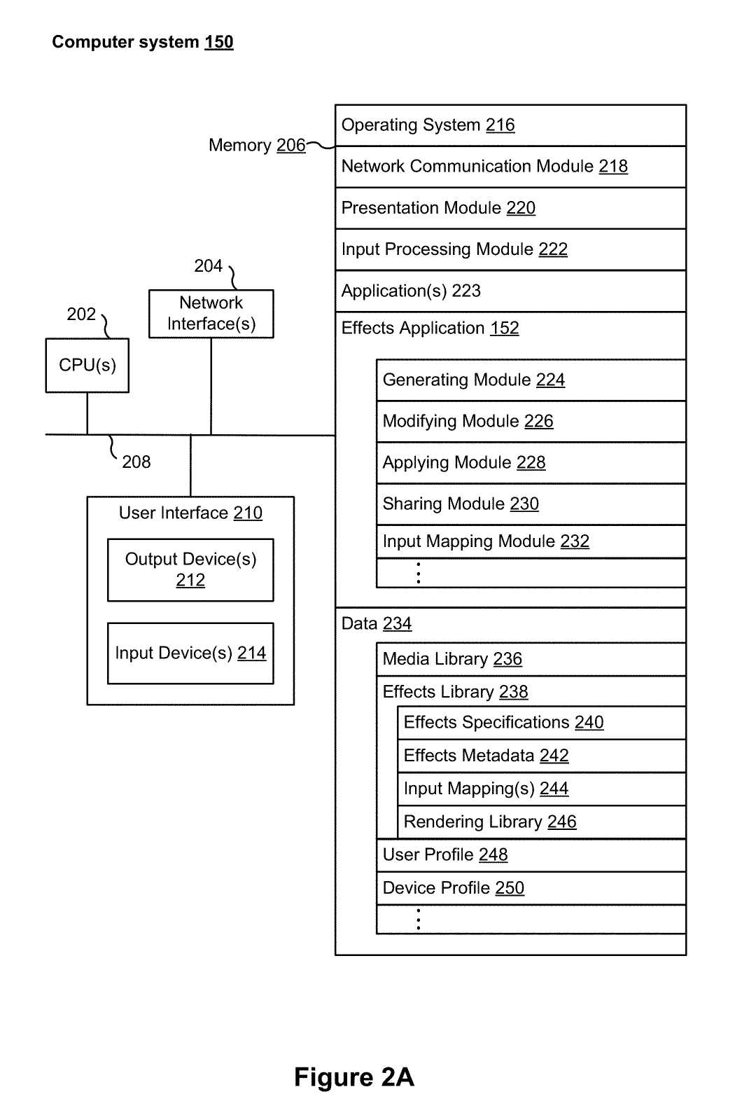

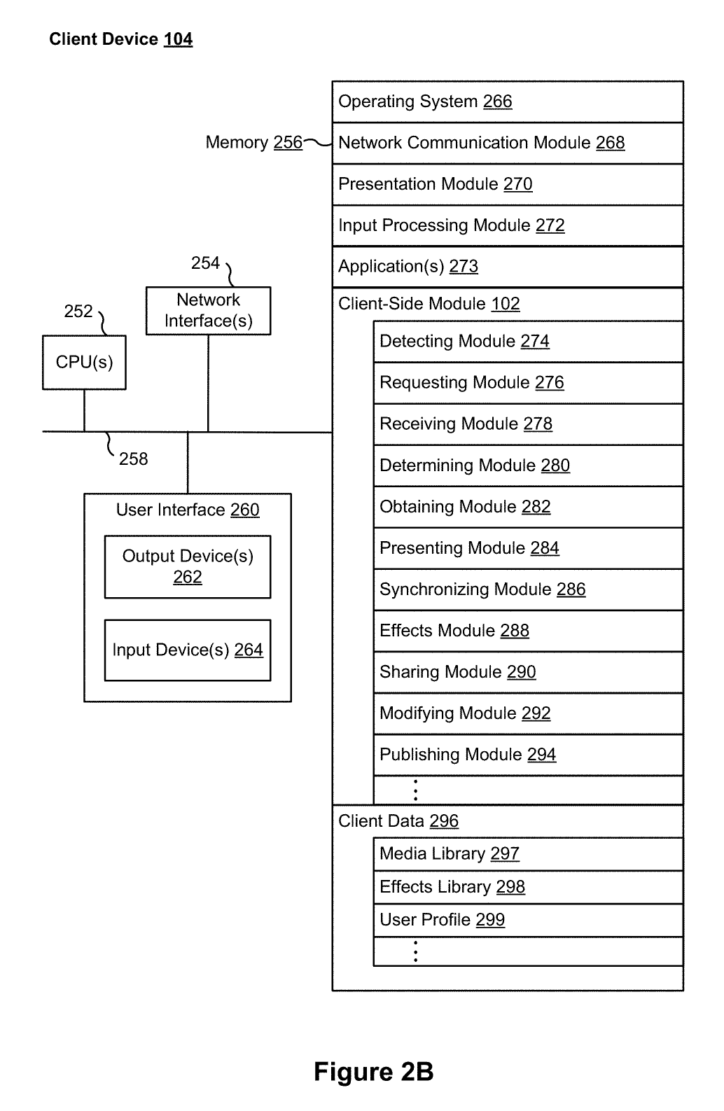

FIG. 2A is a block diagram illustrating a representative computer system 150 in accordance with some implementations. The computer system 150 includes one or more processing units (CPUs) 202, one or more network interfaces 204, memory 206, and one or more communication buses 208 for interconnecting these components (sometimes called a chipset). The computer system 150 also includes a user interface 210. The user interface 210 includes one or more output devices 212 that enable presentation of media content, such as one or more speakers and/or one or more visual displays. The user interface 210 also includes one or more input devices including user interface components that facilitate user input such as a keyboard, a mouse, a voice-command input unit or microphone, an accelerometer, a gyroscope, a touch-screen display, a touch-sensitive input pad, a gesture capturing camera, or other input buttons or controls. Furthermore, some computer systems 150 use a microphone and voice recognition, a camera and gesture recognition, a brainwave sensor/display, or biologically implanted sensors/displays (e.g. digital contact lenses, fingertip/muscle implants, and so on) to supplement or replace the keyboard, display, or touch screen. The memory 206 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. The memory 206, optionally, includes one or more storage devices remotely located from one or more processing units 202. The memory 206, or alternatively the non-volatile memory device(s) within the memory 206, includes a non-transitory computer readable storage medium. In some implementations, the memory 206, or the non-transitory computer readable storage medium of the memory 206, stores the following programs, modules, and data structures, or a subset or superset thereof:
an operating system 216 including procedures for handling various basic system services and for performing hardware dependent tasks;
a network communication module 218 for communicatively coupling the computer system 150 to other computing devices (e.g., server system 108 or client device(s) 104) coupled to the one or more networks 110 via one or more network interfaces 204 (wired or wireless);
a presentation module 220 for enabling presentation of information (e.g., a media item, effect, a user interface for an application or a webpage, audio and/or video content, text, etc.) via the one or more output devices 212 (e.g., displays, speakers, etc.);
an input processing module 222 for detecting one or more user inputs or interactions from one of the one or more input devices 214 and interpreting the detected input or interaction; and
one or more applications 223 for execution by the computer system (e.g., games, social network applications, smart home applications, and/or other web or non-web based applications), such as one or more applications for processing data obtained from one or more of the input device(s) 214.

In some implementations, the memory 206 also includes an effects application 152 for generating, editing, displaying, and/or publishing effects for media items and video streams that includes, but is not limited to:
a generating module 224 for generating a new (static or interactive) audio, visual, or audiovisual effect (e.g., generating a new effects specification 240);
a modifying module 226 for modifying a pre-existing effect so as to generate a new effect based on the pre-existing effect;
an applying module 228 for applying an effect (e.g., previously created effect and/or an effect in development) to a video stream (e.g., a live video stream or a stored video stream) or media item for presentation at an output device 212 or remote display device (e.g., in conjunction with presentation module 220);
a sharing module 230 for sharing the effects via one or more sharing methods (e.g., email, SMS, social media outlets, etc.); and
an input mapping module 232 for mapping effect inputs to device inputs (e.g., mapping a focus movement within the video stream to movement of the device's cursor).

In some implementations, the memory 206 also includes data 234, including, but is not limited to:
a media library 236 storing one or more media files, such as one or more pre-recorded video clips, one or more images, one or more audio files, and/or one or more audiovisual media items.
effects library 238 including functions for implementing one or more real-time or post-processed audio, visual, and/or audiovisual effects (e.g., OpenGL Shading Language (GLSL) shaders), including, but not limited to:
   an effects specifications 240 storing parameters, properties, and/or requirements (e.g., executable code) for each effect in a set of effects;
   effects metadata 242 storing metadata for each effect, such as information regarding identification of the effect, author(s) of the effect, effect creation date/time, effect revision date/time, version number(s), duration of the effect, classification(s) of the effect, effect input(s), cross-reference to related effect(s), and the like;
   input mapping(s) 244 mapping a set of effect inputs to a set of device-specific inputs (e.g., based on the type of the device 104, the operating system 216, the user interface 210, and/or personal preferences of a user of the device 104); and
   a rendering library 246 for rendering effects with one or more video streams, in some implementations, the rendering library 2628 is a shared library (shared across multiple devices);
a user profile 248 including a plurality of user preferences for a user of client device 104; and
a device profile 250 including a plurality of preferences, settings, restrictions, requirements, and the like for the computer system 150.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules or data structures, and thus various subsets of these modules may be combined or otherwise re-arranged in various implementations. In some implementations, the memory 206, optionally, stores a subset of the modules and data structures identified above. Furthermore, the memory 206, optionally, stores additional modules and data structures not described above, such as an output module for pushing effects to remote device(s) for application to a video stream or media item at the remote device(s).

FIG. 2B is a block diagram illustrating a representative client device 104 in accordance with some implementations. The client device 104 includes one or more processing units (CPUs) 252, one or more network interfaces 254, memory 256, and one or more communication buses 258 for interconnecting these components (sometimes called a chipset). The client device 104 also includes a user interface 260. The user interface 260 includes one or more output devices 262 that enable presentation of media content, including one or more speakers and/or one or more visual displays. The user interface 260 also includes one or more input devices including user interface components that facilitate user input such as a keyboard, a mouse, a voice-command input unit or microphone, an accelerometer, a gyroscope, a touch-screen display, a touch-sensitive input pad, a gesture capturing camera, or other input buttons or controls. Furthermore, some client devices 104 use a microphone and voice recognition, a camera and gesture recognition, a brainwave sensor/display, or biologically implanted sensors/displays (e.g. digital contact lenses, fingertip/muscle implants, and so on) to supplement or replace the keyboard, display, or touch screen. The memory 256 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. The memory 256, optionally, includes one or more storage devices remotely located from one or more processing units 252. The memory 256, or alternatively the non-volatile memory device(s) within memory 256, includes a non-transitory computer readable storage medium. In some implementations, memory 256, or the non-transitory computer readable storage medium of memory 256, stores the following programs, modules, and data structures, or a subset or superset thereof:
an operating system 266 including procedures for handling various basic system services and for performing hardware dependent tasks;
a network communication module 268 for connecting user device 104 to other computing devices (e.g., server system 108, audio sources 124a . . . 124n, and media file sources 126a . . . 126n) connected to one or more networks 110 via one or more network interfaces 204 (wired or wireless);
a presentation module 270 for enabling presentation of information (e.g., a media item, effect, a user interface for an application or a webpage, audio and/or video content, text, etc.) via one or more output devices 212 (e.g., displays, speakers, etc.);
an input processing module 272 for detecting one or more user inputs or interactions from one of the one or more input devices 214 and interpreting the detected input or interaction; and
one or more applications 273 for execution by the client device (e.g., games, social network applications, smart home applications, and/or other web or non-web based applications), such as one or more applications for processing data obtained from one or more of the input device(s) 264.

In some implementations, the memory 256 also includes a client-side module 102 for creating, exploring, and playing back media items and/or effects that includes, but is not limited to:
a detecting module 274 for detecting one or more user inputs corresponding to the application;
a requesting module 276 for querying a server (e.g., server system 108) for a media item, media item metadata, effect, and/or effect metadata;
a receiving module 278 for receiving, from server system 108, one or more media files (e.g., one or more video clips and/or one or more images), information identifying one or more audio files or visual media files for the requested media item, information identifying one or more audio and/or video effects (e.g., static and/or interactive effects), and/or metadata for the media item or effects;
a determining module 280 for determining a source for a requested file, such as an audio file, visual media file, or effect;
an obtaining module 282 for obtaining one or more files for the requested media item or effect;
a presenting module 284 for presenting a media item and/or effect via one or more output devices 262 (e.g., presenting a video stream with an effect applied);
a synchronizing module 286 for synchronizing audio files and visual media files of a media item;
an effects module 288 for presenting, developing, and/or distributing audio, visual, and/or audiovisual effects (e.g., static and/or interactive effects);
a sharing module 290 for sharing the media item via one or more sharing methods (e.g., email, SMS, social media outlets, etc.);
a modifying module 292 for modifying a pre-existing media item or effect so as to generate a new media item or effect based on the pre-existing item; and
a publishing module 294 for publishing media items and/or effects (e.g., publishing to social media outlet(s) via a remote server).

In some implementations, the memory 256 also includes client data 296, including, but is not limited to:
a media library 297 one or more media files, such as on or more pre-recorded video clips, one or more images, and/or one or more audio files;
an effects library 298 including functions for implementing one or more real-time or post-processed audio, visual, and/or audiovisual effects (e.g., OpenGL Shading Language (GLSL) shaders); and
a user profile 299 including a plurality of user preferences for a user of client device 104.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules or data structures, and thus various subsets of these modules may be combined or otherwise re-arranged in various implementations. In some implementations, the memory 256, optionally, stores a subset of the modules and data structures identified above. Furthermore, the memory 256, optionally, stores additional modules and data structures not described above, such as a distributing module for pushing content, such as custom effects, to a plurality of remote devices.

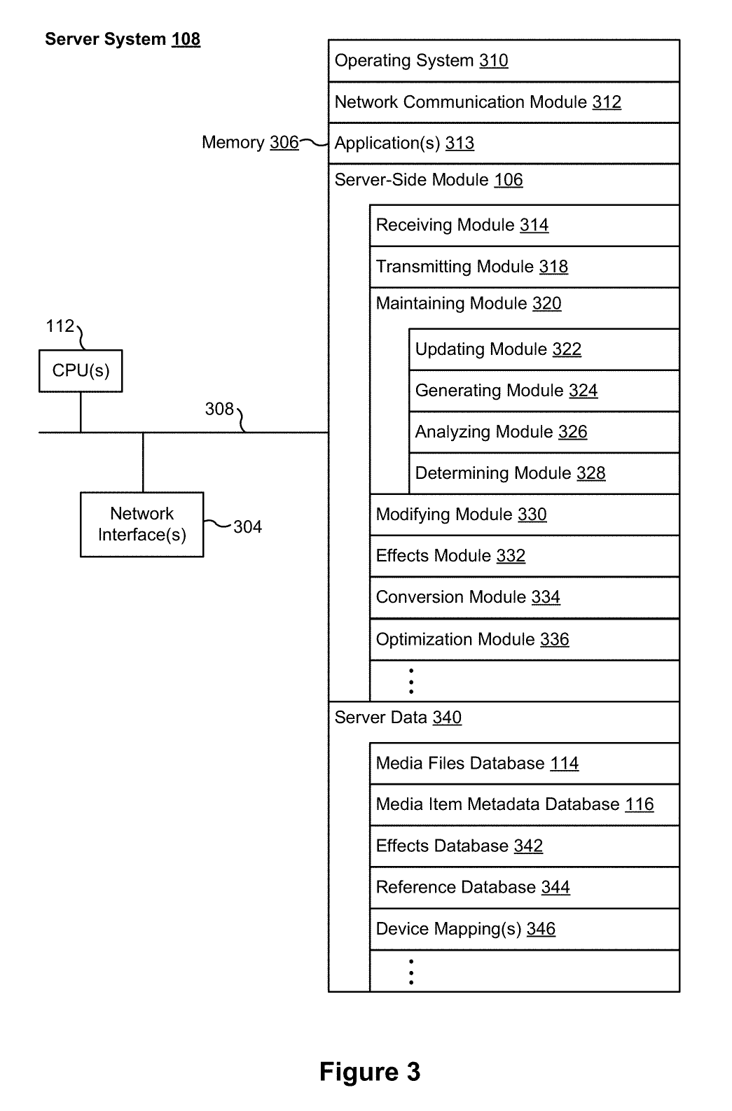

FIG. 3 is a block diagram illustrating server system 108 in accordance with some implementations. The server system 108, typically, includes one or more processing units (CPUs) 112, one or more network interfaces 304 (e.g., including I/O interface to one or more clients 118 and I/O interface to one or more external services 120), memory 306, and one or more communication buses 308 for interconnecting these components (sometimes called a chipset). The memory 306 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. The memory 306, optionally, includes one or more storage devices remotely located from one or more processing units 112. The memory 306, or alternatively the non-volatile memory device(s) within the memory 306, includes a non-transitory computer-readable storage medium. In some implementations, the memory 306, or the non-transitory computer-readable storage medium of the memory 306, stores the following programs, modules, and data structures, or a subset or superset thereof:
an operating system 310 including procedures for handling various basic system services and for performing hardware dependent tasks;
a network communication module 312 that is used for connecting server system 108 to other computing devices (e.g., client devices 104, audio sources 124a . . . 124n, and media file sources 126a . . . 126n) connected to one or more networks 110 via one or more network interfaces 304 (wired or wireless);
one or more applications 313 for execution by the server system (e.g., games, social network applications, smart home applications, and/or other web or non-web based applications), such as one or more applications for processing data received from one or more client devices;
a server-side module 106 of an application for generating, exploring, and presenting media items and/or effects that includes, but is not limited to:
   a receiving module 314 for receiving requests (e.g., from client devices 104) to transmit a media item or effect, or a component thereof, and/or for receiving effects and/or media items, or updates to such items and effects, from remote devices (e.g., from client devices 104);
   a transmitting module 318 for transmitting information to remote devices (e.g., as client devices 104), such as media items and/or effects, or components thereof (e.g., visual media files, metadata, and the like); and
   a maintaining module 320 for maintaining one or more databases, such as the media item metadata database 116, effects database 342, and/or media files database 114, the maintaining module 320 including, but not limited to:
      an updating module 322 for updating one or more fields, tables, and/or entries in a database, for example, updating a metadata structure for a respective media item (e.g., play count, likes, shares, comments, associated media items, and so on);
      a generating module 324 for generating a new entry in a database, such as a new metadata structure or a new effect;
      an analyzing module 326 for analyzing entries in the one or more databases (e.g., to determine a source for a particular object, or to determine an appropriate mapping for the object); and
      a determining module 328 for determining whether a particular object is stored within a particular database (e.g., for determining whether a particular visual media file is stored within the media files database 114);
   a modifying module 330 for flattening a media item into a single stream or digital media item or for re-encoding media items for different formats and bit rates;
   an effects module 332 for receiving and transmitting video, audio, and/or audiovisual effects (e.g., static and/or interactive effects) as scripts or computer-readable instructions (e.g., GLSL shaders for use with OpenGL ES), or transmitting/receiving effect components such as effects metadata (e.g., effect type, effect version, content, effect parameters, and so on) and/or effect specifications;
   a conversion module 334 for converting file types, formats, bit rates, and the like (e.g., in conjunction with modifying module 330) for media items, visual media files, audio files, effects, and the like; and
   an optimization module 336 for optimizing media items, effects, and the like based on device types, device parameters, device operating systems, network parameters, user preferences, and the like; and
server data 340, including but not limited to:
   a media files database 114 storing one or more audio, visual, and/or audiovisual media files (e.g., images and/or audio clips);
   a media item metadata database 116 storing a metadata structure for each media item, where each metadata structure identifies one or more visual media files, one or more audio files, and/or one or more effects for the media item;
   an effects database 342 storing one or more real-time or post-processed audio, visual, and/or audiovisual effects (e.g., as scripts or computer-readable instructions), and/or storing effect metadata corresponding to effect type, effect version, content, effect parameters, a table mapping of interactive input modalities to effect parameters for real-time effect interactivity, and so on;
   a reference database 344 storing a plurality of reference audio files, visual files, and associated parameters and preferences; and
   device mapping(s) 346 storing one or more mappings of effect input parameters to device inputs, such as mappings corresponding to particular devices, device types, sets of device inputs, device operating systems, and the like.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, or modules, and thus various subsets of these modules may be combined or otherwise re-arranged in various implementations. In some implementations, the memory 306, optionally, stores a subset of the modules and data structures identified above. Furthermore, the memory 306, optionally, stores additional modules and data structures not described above.

Attention is now directed towards implementations of user interfaces and associated processes that are optionally implemented on a respective computer system 150, client device 104, display device, or combination thereof.

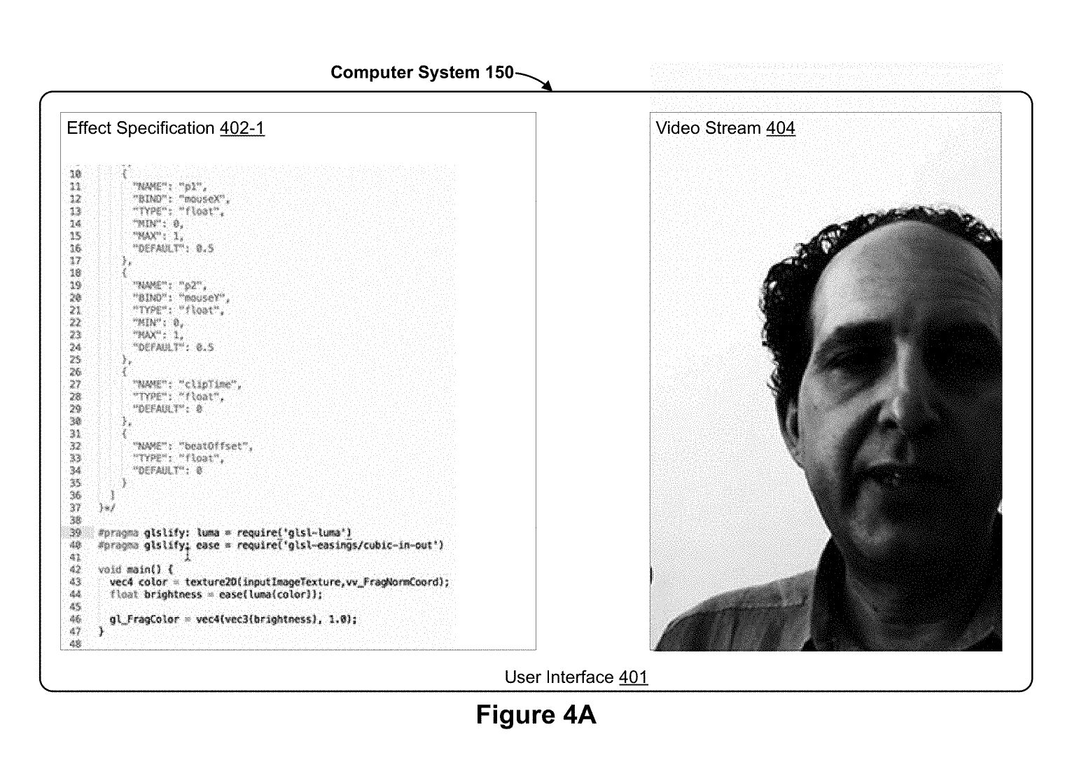

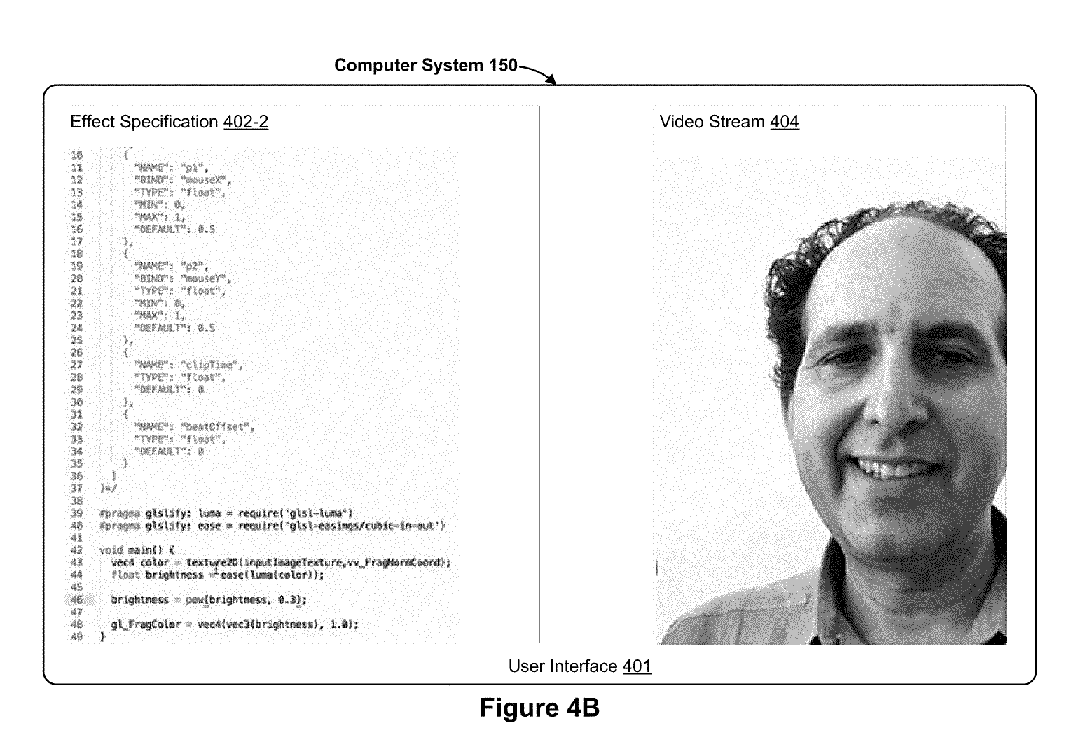

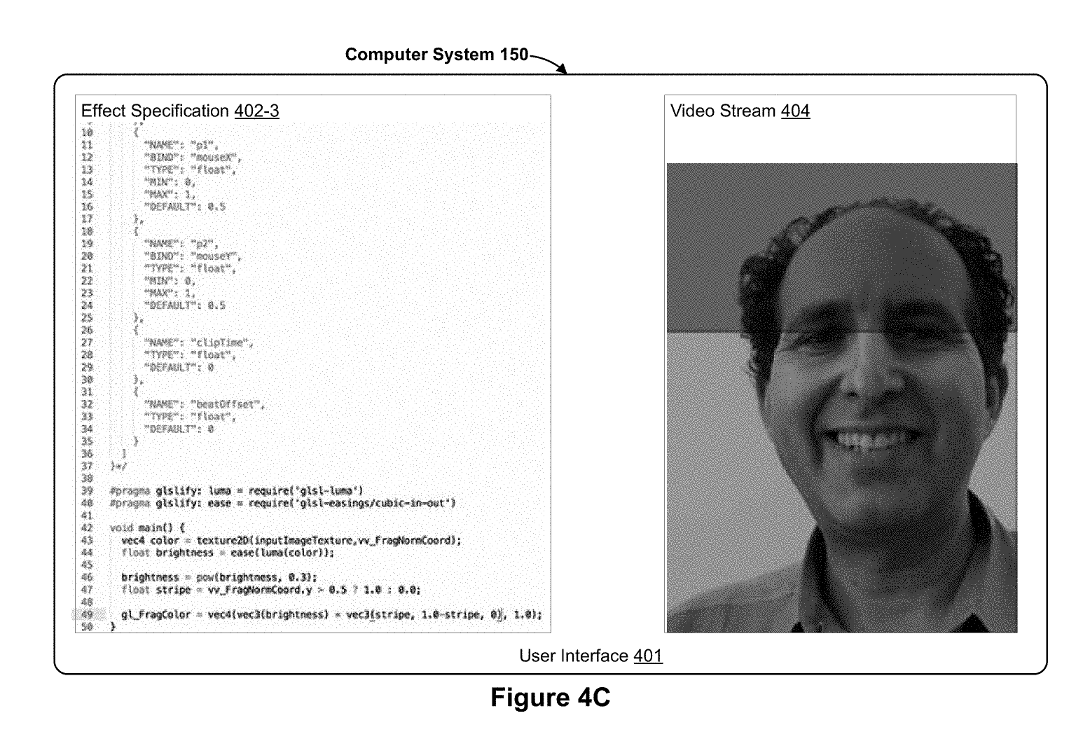

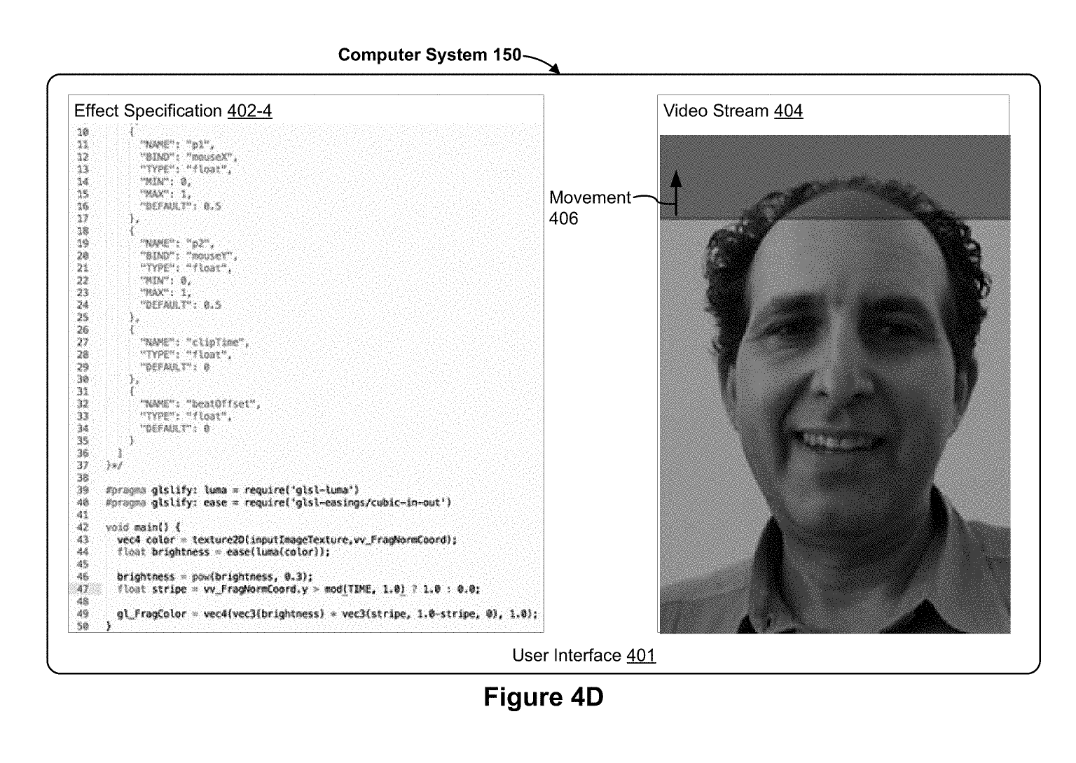

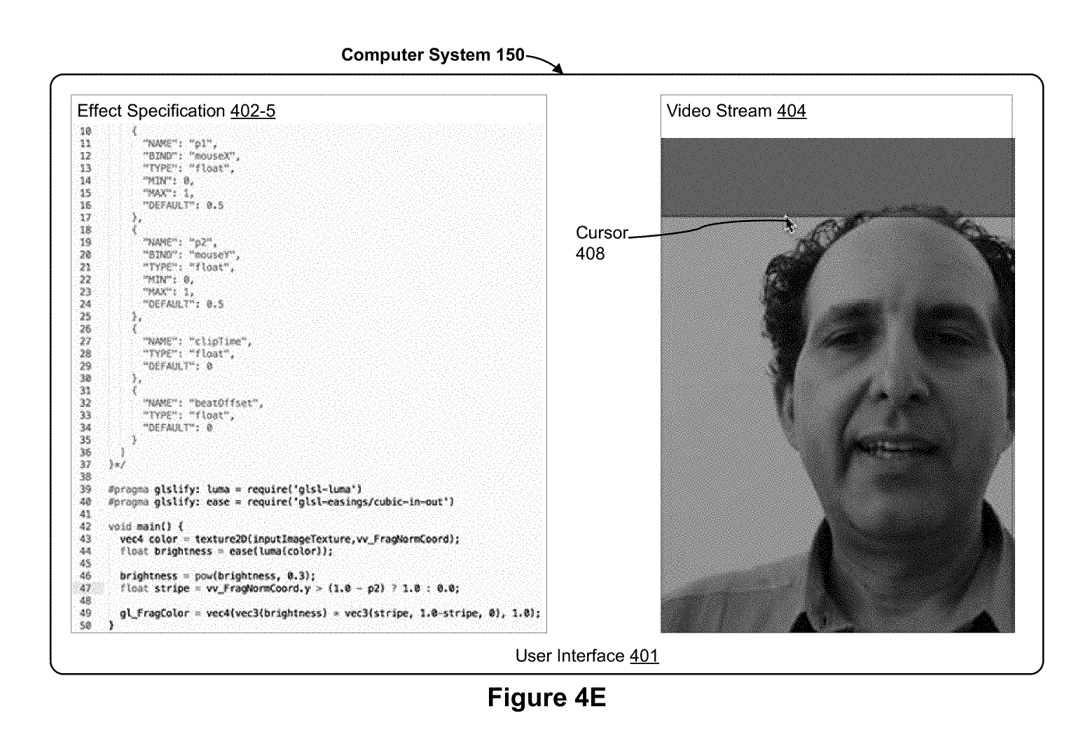

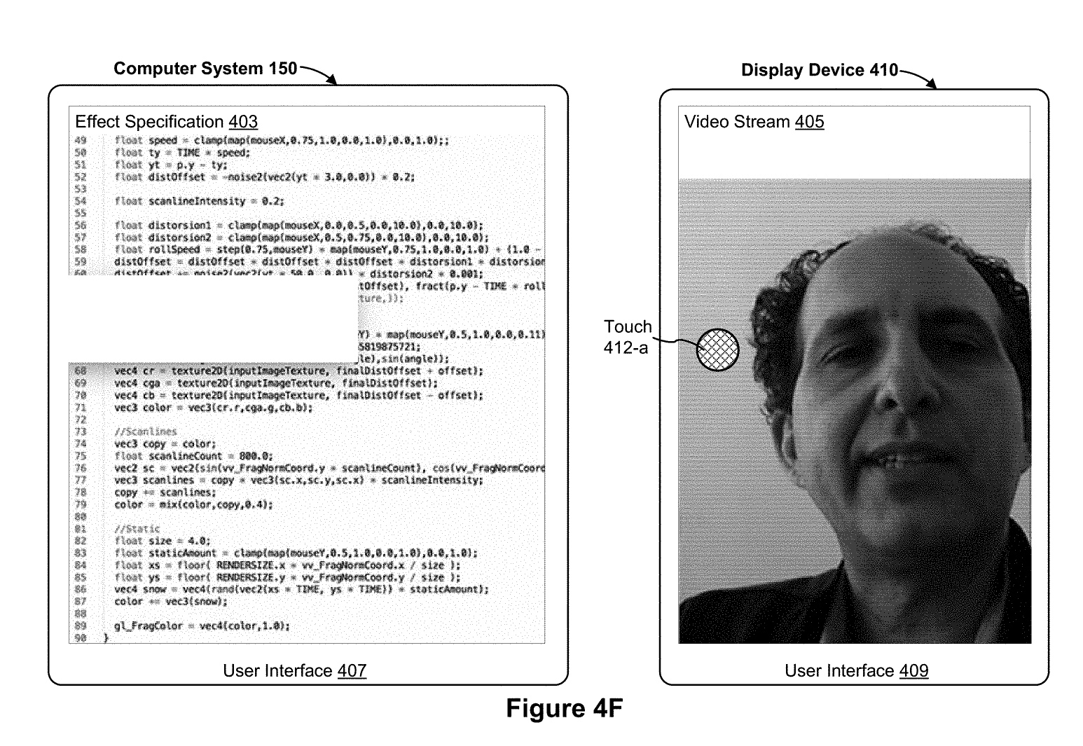

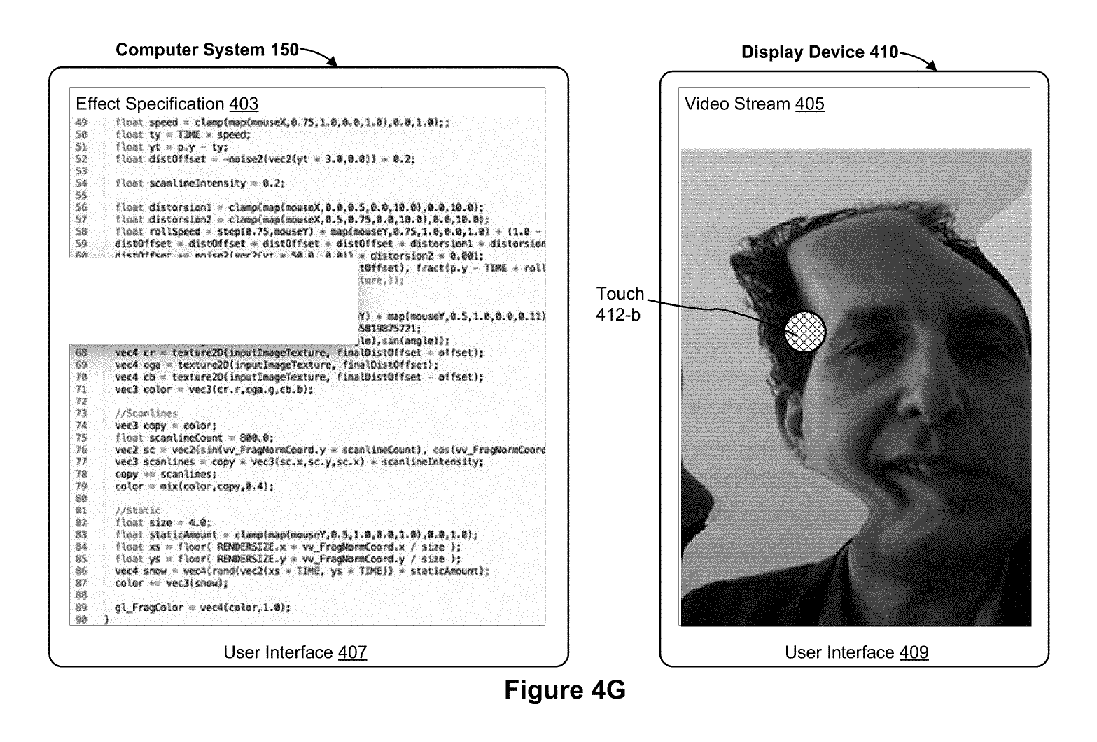

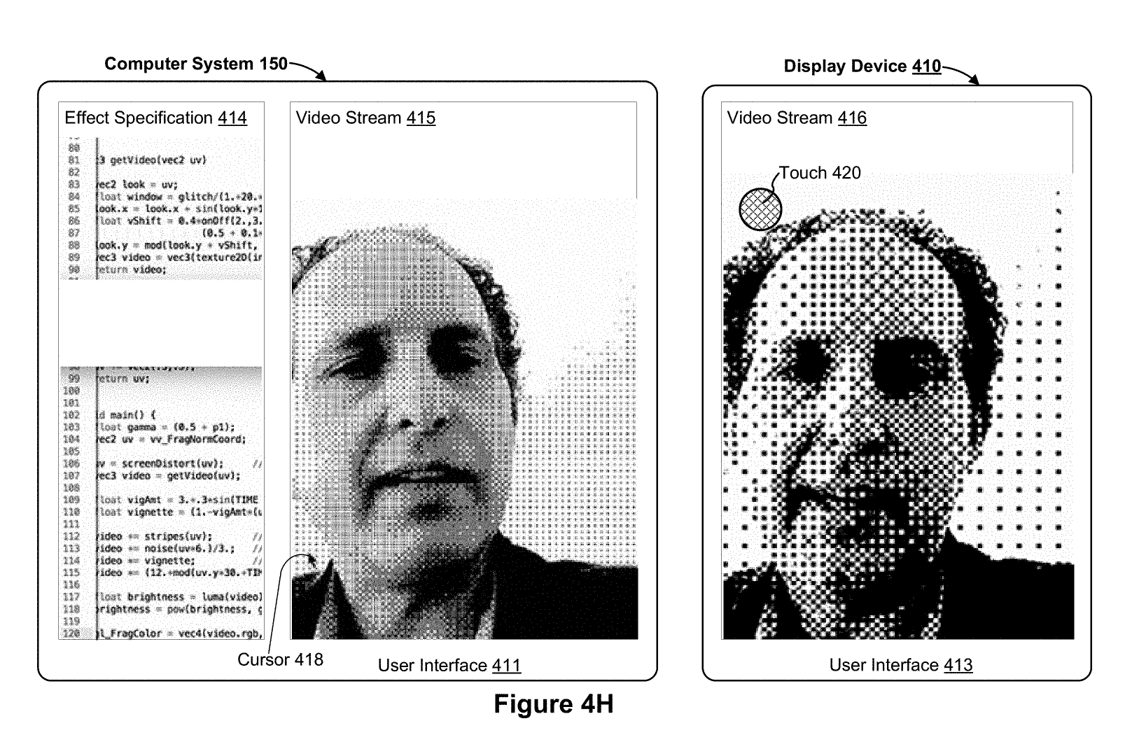

FIGS. 4A-4H illustrate representative user interfaces for developing media item effects in accordance with some implementations. FIG. 4A shows a computer system 150 having a user interface 401 that includes an effect specification 402 in a first state (402-1) and a video stream 404. In some implementations, the computer system 150 comprises a client device 104. The video stream 404 in FIG. 4A has the effect specified by the effect specification 402 applied to it. The video stream 404 is optionally a live video stream (e.g., captured by a camera of the client device) or a stored video stream (e.g., a video stream from the media library 236). In the example shown in FIG. 4A the effect specification comprises executable code for the effect. In some implementations, the effect specification includes one or more parameters, properties, and/or fields that are adjustable by a user of the client device. In some implementations, the effect specification comprises a graphical user interface (GUI). In some implementations, effect parameters are displayed within the GUI as adjustable values (e.g., adjustable via a displayed slider, dial, or the like). In some implementations, the effect specification comprises a text file loaded into a graphical processor unit (GPU) of the computer system 150. In some instances and implementations, loading the effect specification into the GPU enables a real-time response of the effect applied to the video stream 404 to changes within the effect specification 402. In some implementations, the computer system 150 is configured to save updates to the effect specification 402 (e.g., periodically save, or save in response to user inputs) and automatically, without further user input, apply the updated effect to the video stream 404 (e.g., in real-time). In some implementations, after updating the effect specification, the specification is compiled (e.g., compiled by a CPU of the device) and rendered on the video stream 405 (e.g., rendered by a GPU of the device).

In some implementations, the effect specified by the effect specification comprises a mask, shader, filter, modification of a temporal order or speed of the video stream, modification of a geometry of at least a portion of the video stream, or a combination thereof. In some implementations, the computer system 150 includes an effects editor application and the editor application has the effect specifications, including effect specification 402. In some implementations, the effects editor application is configured to create and apply effects, such as shaders and filters, to video streams. In some implementations, the effects editor application utilizes a pre-compiler and renderer to apply the effects specified by the effect specifications to the video streams. In some implementations, modifications to the effect specification within the effects editor are passed to the renderer to update the effect applied to the video stream 404 (e.g., automatically, without further user input, and in real-time). In some implementations, the effects editor application is configured to publish or share effects (e.g., effect specifications and/or effect metadata) in response to a user request (e.g., a user selection of a publish or share button in the user interface). In some implementations, the effects editor is configured to push published effects to client devices (e.g., client devices having a particular effects editor application or media item application). In some implementations, the effect specifications are transmitted to a server system (e.g., server system 108, FIG. 3) for storage and/or publications.

FIG. 4B shows the user interface 401 including the effect specification 402 in a second state (402-2) and the video stream 404 with an updated effect applied to it. In FIG. 4B the effect specification 402 has been edited to modify (increase) a brightness of the effect (e.g., at line 46 in the specification). Thus, the video stream 404 in FIG. 4B is brighter than the video stream 404 in FIG. 4A.

FIG. 4C shows the user interface 401 including the effect specification 402 in a third state (402-3) and the video stream 404 with an updated effect applied to it. In FIG. 4C the effect specification 402 has been edited to apply a color stripe to the video stream (e.g., at line 49 in the specification). Thus, the video stream 404 in FIG. 4C shows a color stripe with green at the bottom and read at the top applied to the video stream. The positioning of the color stripe in FIG. 4C is constant based on a set value (e.g., set at line 47 in the specification).

FIG. 4D shows the user interface 401 including the effect specification 402 in a fourth state (402-4) and the video stream 404 with an updated effect applied to it. In FIG. 4D the effect specification 402 has been edited to apply a time-based color stripe to the video stream (e.g., at lines 47 and 49 in the specification). Thus, the video stream 404 in FIG. 4D shows a color stripe applied to the video stream that varies with time. The color stripe in FIG. 4D shifts vertically over time as shown by movement vector 406. As shown in FIG. 4D, in some implementations, the effects (e.g., one or more discernable characteristics of the effects) are responsive to external inputs, such as cursor movements and locations, data from a gyroscope or accelerometer, audio inputs, visual inputs, time, and the like. In some implementations, analysis of these inputs (e.g., analysis external to the effects editor application) is used to update the effects (e.g., one or more discernable characteristics of the effects), such as beat detection, facial recognition, object recognition, voice recognition, word recognition, color recognition, audio/visual fingerprinting, and the like. In some implementations, one or more discernable characteristics of the effect are based on user preferences and/or a user profile of the user (e.g., name, location, affiliations, etc.).

In some implementations, the effects are responsive to external inputs during a creation phase of a media item. Thus, an author of a media item customizes how effects are applied to a particular video/audio stream within the media item. In some implementations, the author determines how and when particular effects are applied to the media item. For example, an author activates an effect and adjusts one or more discernable characteristics of the effect while recording one or more video streams for the media item. In this example, the video files of the media item store the video streams with the effects applied.

In some implementations, the effects are responsive to external inputs during playback of a media item. Thus, a viewer of the media item determines how the effects are applied to the media item. For example, while watching the media item, the viewer at any time may perform a gesture (such as a swipe gesture) to activate a particular effect applied to the media item. In some implementations, the effect is applied to the media item and one or more discernable characteristics of the effect are updated based on one or more parameters of each viewer's device. For example, an effect based on gyroscope data is applied to a particular media item and one or more discernable characteristics of the effect are updated based on the orientation of the client device during playback of the media item. In some implementations, an author of a media item determines which effects are associated with the media item and determines which inputs activate, or impact discernable characteristics of, each effect. In some implementations, the viewers of the media item are then enabled to optionally activate and/or adjust discernable characteristics of the effect during playback of the media item.

FIG. 4E shows the user interface 401 including the effect specification 402 in a fifth state (402-5) and the video stream 404 with an updated effect applied to it. In FIG. 4E the effect specification 402 has been edited to apply a focus-based color stripe to the video stream (e.g., at line 47 in the specification). Thus, the video stream 404 in FIG. 4E shows a color stripe applied to the video stream that varies based on the position of the cursor 408. In this example, the focus position is mapped to the device's cursor position. In some implementations, the focus position is mapped to a touch input location.

FIG. 4F shows the computer system 150 with a user interface 407 that includes an effect specification 403. FIG. 4F also shows a display device 410 (e.g., a second computer system 150 or a client device 104) with a user interface 409 that includes a video stream 405. The video stream 405 has the effect specified by the effect specification 403 applied to it. The effect in the example of FIGS. 4F-4G distorts the video stream image based on the horizontal (x-axis) position of the focus, where there is little distortion when the focus is on the left side of the video stream and large distortion when the focus on the right side of the video stream (e.g., lines 56-60 of the specification 403). FIG. 4F further shows a touch input 412 at position 412-a on the left side of the video stream 405. The computer system 150 is communicatively coupled to the display device 410. In some implementations, the computer system 150 is coupled to the display device 410 via one or more wireless networks (e.g., Wi-Fi or Bluetooth), one or more wired networks (e.g., Ethernet), and/or one or more wired connections (e.g., USB or FireWire).

In some implementations, the effect specification 403 (or an effects editor application having the effect specification) is configured to enable a user to optimize an effect at the computer system 150 for display at the display device 410. Thus a user of the computer system 150 may evaluate (e.g., in real-time) how the effect looks and/or runs on the display device 410. The user of the computer system 150 may optimize the effect based on the operating system, device parameters, device inputs, etc. of the display device 410.

FIG. 4G shows the computer system 150 with the user interface 407 that includes the effect specification 403. FIG. 4F also shows the display device 410 with the user interface 409 that includes the video stream 405. As discussed with respect to FIG. 4F, the video stream 405 has the effect specified by the effect specification 403 applied to it. FIG. 4G further shows a touch input 412 at position 412-b near the middle of the video stream 405. As a result of the touch input position, FIG. 4G shows greater distortion applied to the video stream 405 compared to FIG. 4F.

FIG. 4H shows the computer system 150 with a user interface 411 that includes an effect specification 414 and a video stream 415. FIG. 4H also shows a display device 410 (e.g., a mobile device) with a user interface 413 that includes a video stream 416. The video streams 415 and 416 have the effect specified by the effect specification 414 applied to them concurrently. The effect in the example of FIG. 4H pixelates the video stream image based on the vertical (y-axis) position of the focus, where there is little pixilation when the focus is on the bottom of the video stream and large pixilation when the focus on the top of the video stream. FIG. 4H further shows a cursor 418 near the bottom of video stream 415 (resulting in little pixilation of video stream 415) and a touch input 420 near the top of the video stream 416 (resulting in larger pixilation of video stream 416). In the example of FIG. 4H the focus position is mapped to a cursor position at the computer system 150 and is mapped to a touch input position at the display device 410.

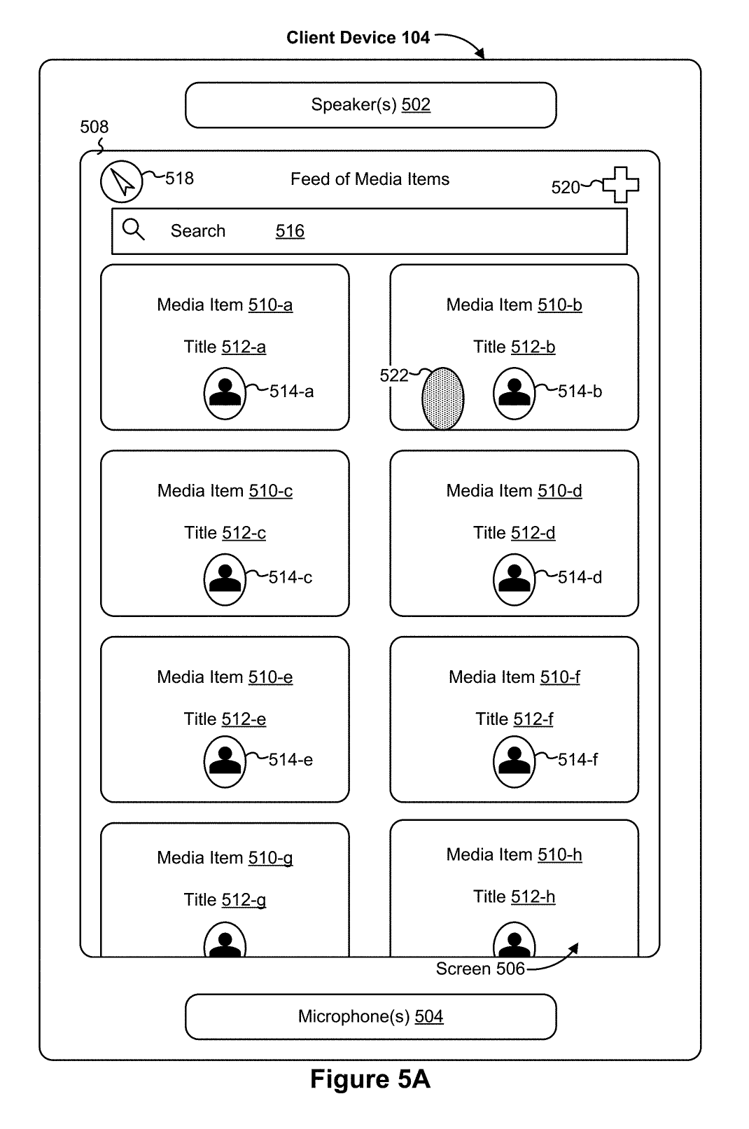

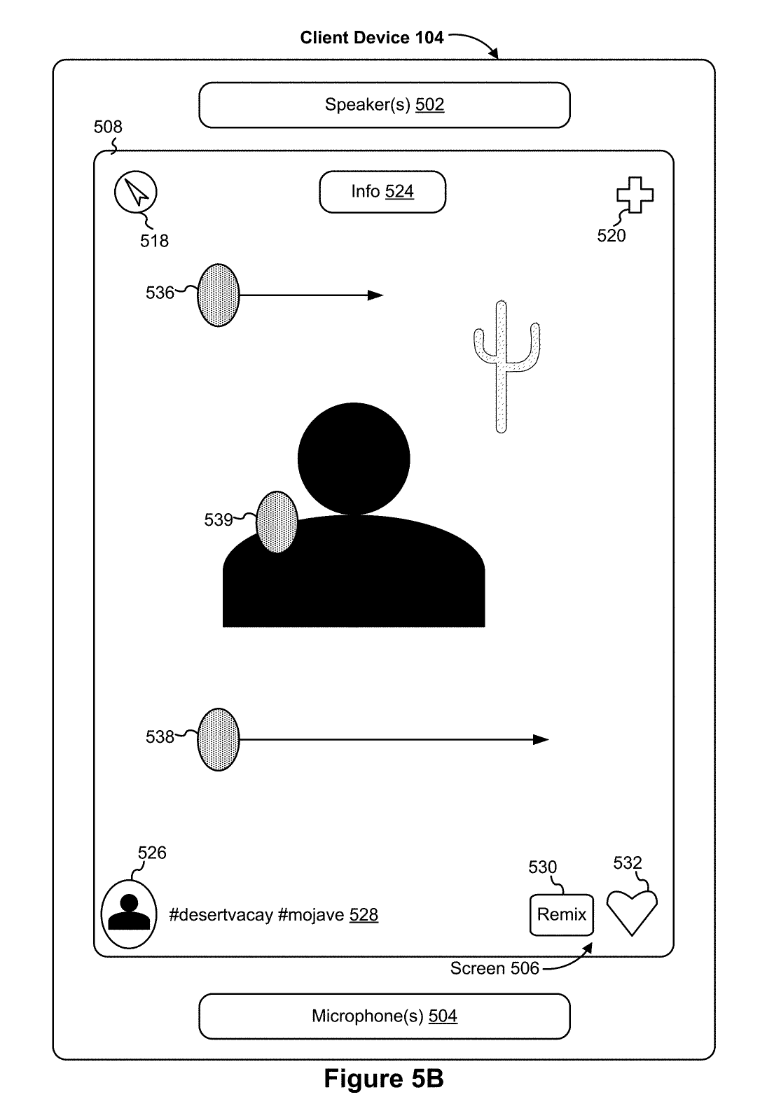

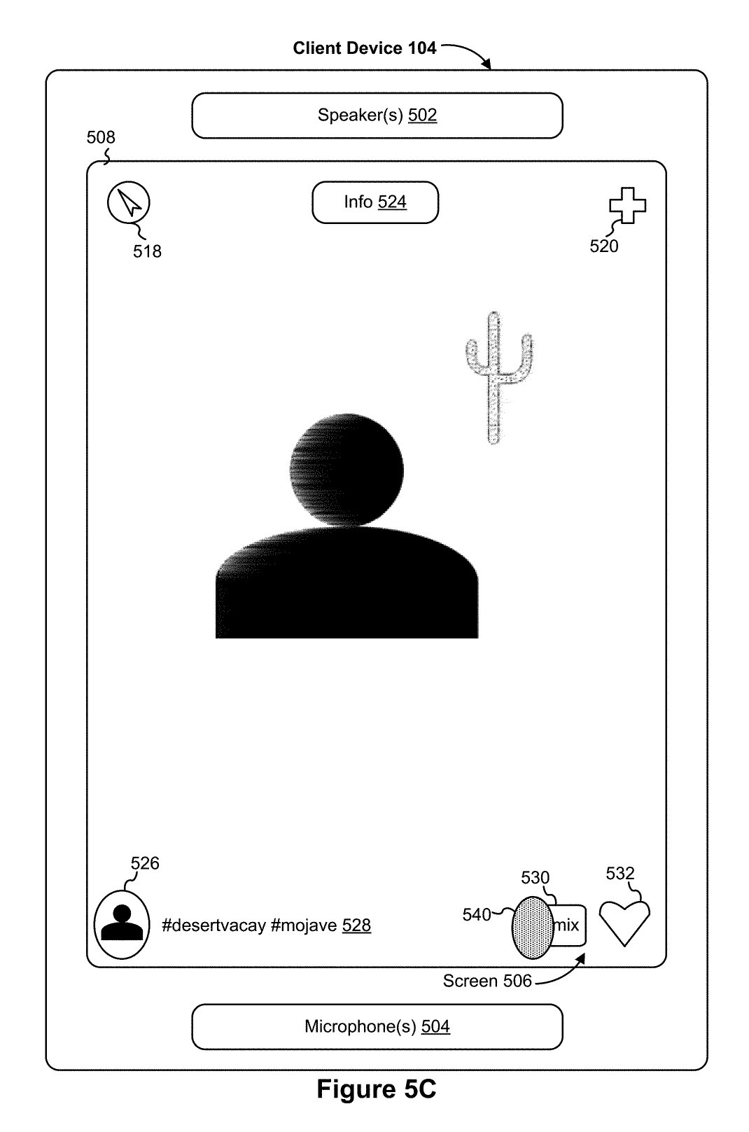

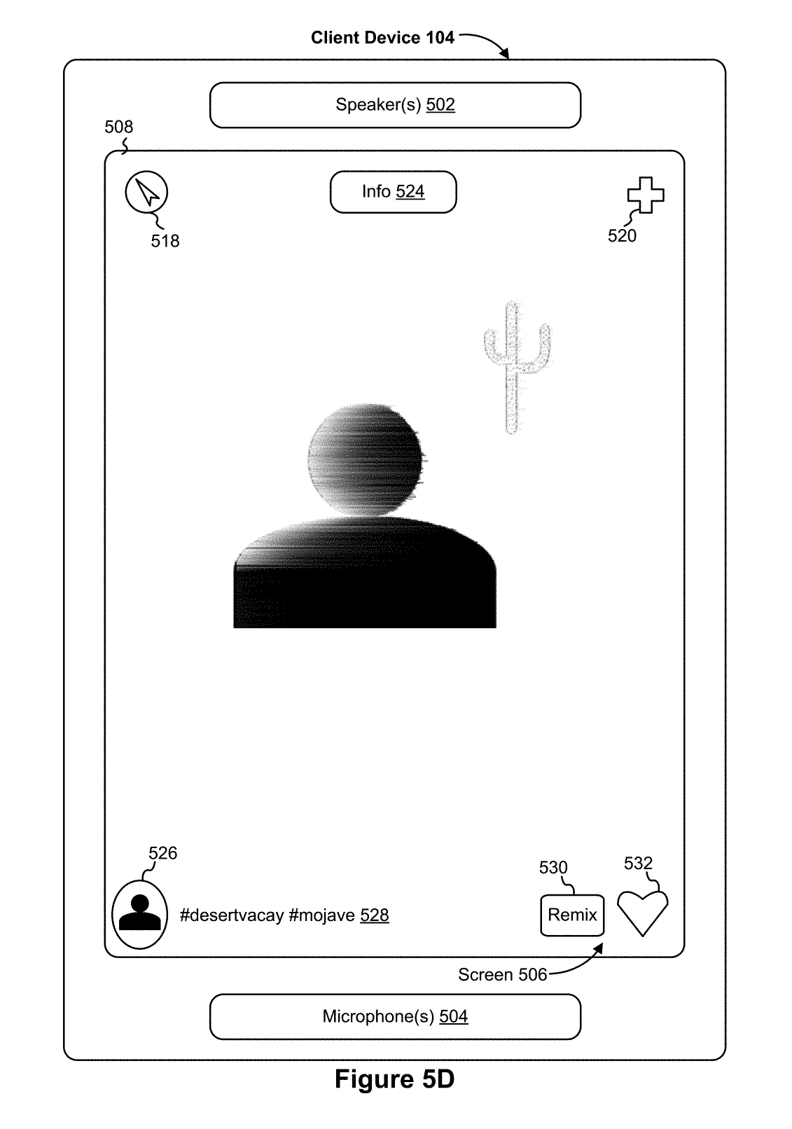

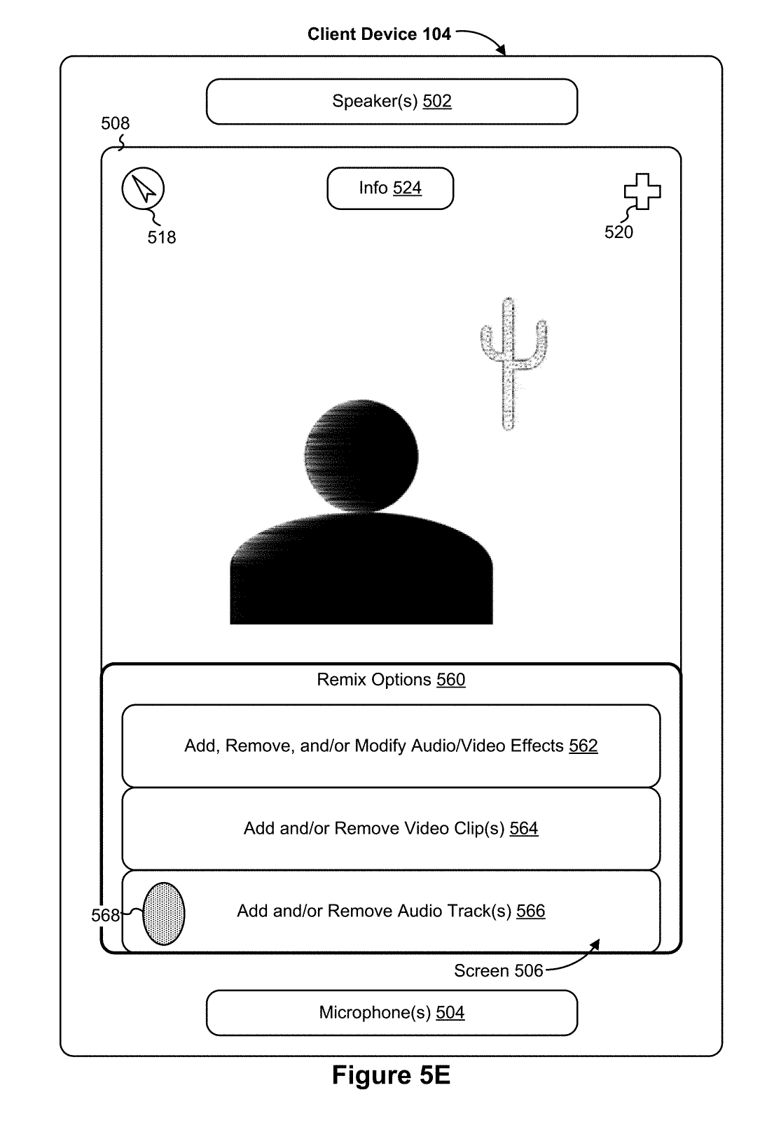

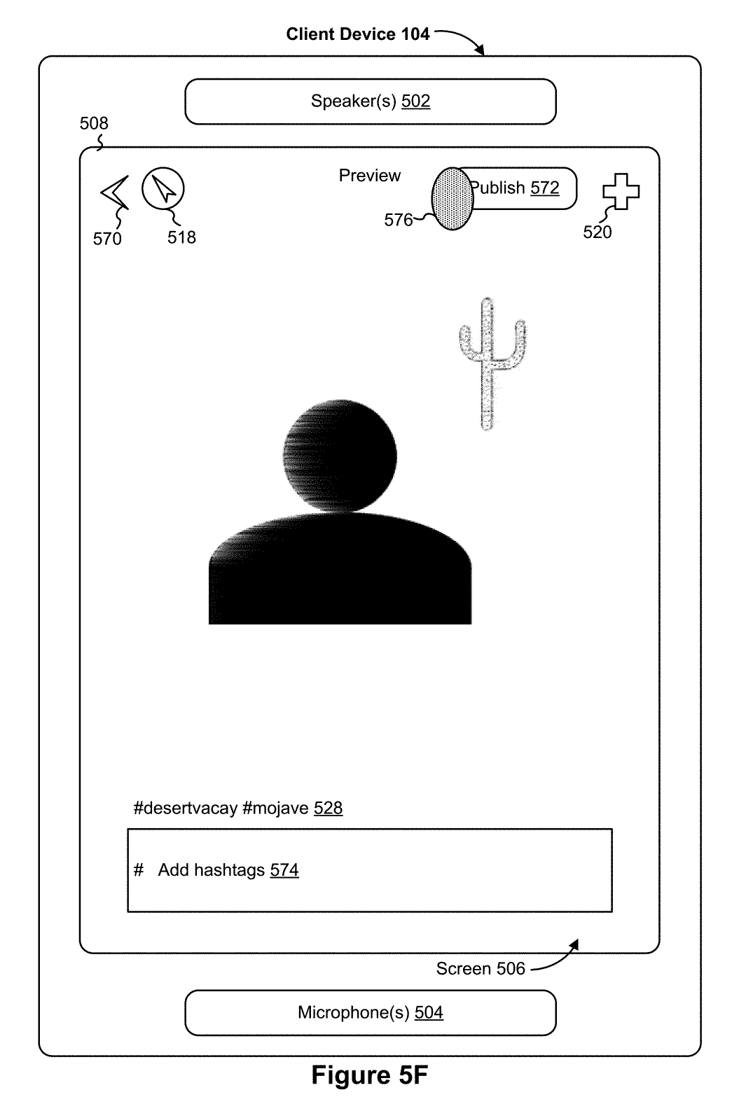

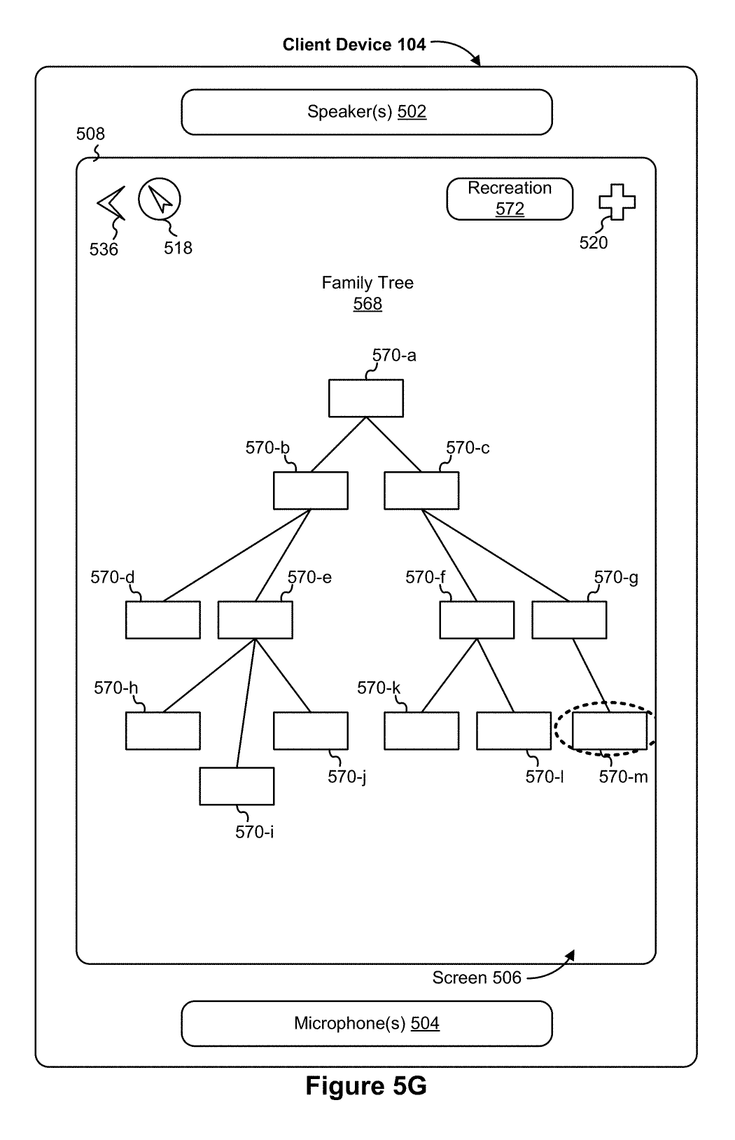

FIGS. 5A-5G illustrate representative user interfaces for presenting interactive media items in accordance with some implementations. Although some of the examples that follow will be given with reference to inputs on touch screen 506 (where the touch sensitive surface and the display are combined), in some implementations, the device detects inputs via one or more input devices (e.g., a mouse or keyboard), or on a touch-sensitive surface that is separate from the display. In some implementations, the touch sensitive surface has a primary axis that corresponds to a primary axis on the display. In accordance with these implementations, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some implementations, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIGS. 5A-5G show a user interface 508 displayed on a client device 104 (e.g., a laptop computer) for an application for generating, exploring, and presenting media items. One skilled in the art will appreciate that the user interfaces shown in FIGS. 5A-5G could be implemented on other similar computing devices (e.g., desktop computers, tablets, etc.).

FIG. 5A illustrates the client device 104 displaying a user interface for a feed view of the application that includes a feed of media items on touch screen 506. In FIG. 5A, the user interface includes a plurality of media item affordances 510 corresponding to media items generated by users in a community of users and search query box 516 configured to enable the user of client device 104 to search for media items. In some implementations, media affordances 510 corresponding to sponsored media items are displayed at the top or near the top of the feed of media items. In some implementations, advertisements are concurrently displayed with the feed of media items such as banner advertisements or advertisements in a side region of the user interface. In some implementations, one or more of media item affordances 510 correspond to media items that are advertisements. In FIG. 5A, each of media item affordances 510 includes a title 512 of the corresponding media item and a representation 514 of the user in the community of users who authored the corresponding media item. For example, each of representations 514 includes an image associated with the author of the media item (e.g., a headshot or avatar) or an identifier, name, or handle associated with the author of the media item. In some implementations, a respective representation 514, when activated (e.g., by a touch input from the user), causes client device 104 to display a profile associated with the author of the corresponding media item.

In FIG. 5A, the user interface also includes a navigation affordance 518, which, when activated (e.g., by a touch input from the user), causes client device 104 to display a navigation panel for navigating between user interfaces of the application (e.g., one or more of a feed view, user profile, user media items, friends view, exploration view, settings, and so on) and a creation affordance 520, which, when activated (e.g., by a touch input from the user), causes client device 104 to display a first user interface of a process for generating a media item. In FIG. 5A, the user interface includes a portion of media item affordances 510-g and 510-h indicating that the balance of the media items can be viewed by scrolling downwards in the feed view. FIG. 5A also illustrates client device 104 detecting contact 522 at a location corresponding to media item affordance 510-b.

For example, in response to detecting contact 522 selecting media item affordance 510-b in FIG. 5A, client device 104 sends a notification to server system 108 to update a play count field in the metadata structure associated with the respective media item (e.g., play count field 526 in FIG. 5). In this example, in response to receiving the notification, server system 108 or a component thereof (e.g., updating module 322, FIG. 3) updates play count field 526, as shown in FIG. 5, in a metadata structure associated with the respective media item corresponding to media item affordance 510-b to reflect the notification.

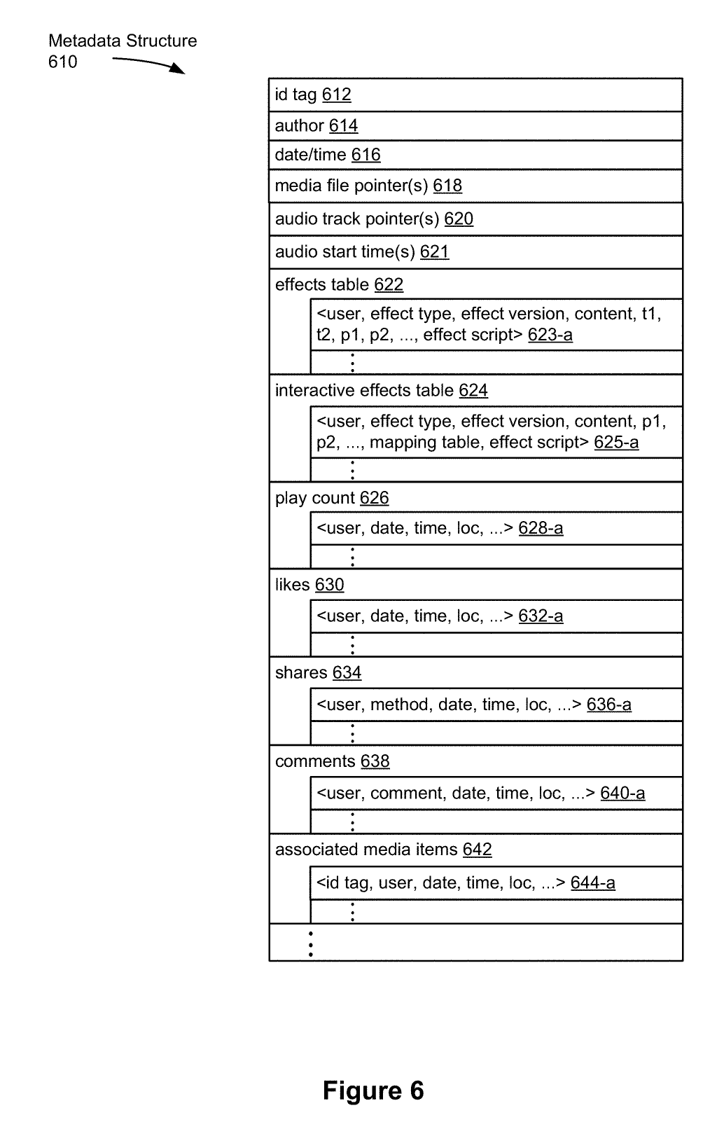

FIG. 5B illustrates client device 104 presenting a respective media item on touch screen 506 that corresponds to media item affordance 510-b in response to detecting contact 522 selecting media item affordance 510-b in FIG. 5A. In FIG. 5B, the user interface includes information affordance 524, which, when activated (e.g., by a touch input from the user), causes client device 104 to display an informational user interface with information and one or more options associated with the respective media item and representation 526, which, when activated (e.g., by a touch input from the user), causes client device 104 to display a profile associated with the author of the respective media item. For example, representation 526 is an image associated with the author of the respective media item (e.g., a headshot or avatar) or an identifier, name, or handle associated with the author of the respective media item. In FIG. 5B, the user interface also includes hashtags 528 associated with the respective media item, remix affordance 530, which, when activated (e.g., by a touch input from the user), causes client device 104 to display options (e.g., remix options 560 in FIG. 5M) for modifying the respective media item, and like affordance 532, which, when activated (e.g., by a touch input from the user), causes client device 104 to send a notification to server system 108 to update a like field in the metadata structure associated with the respective media item (e.g., likes field 530 in FIG. 5). For example, in response to receiving the notification, server system 108 or a component thereof (e.g., updating module 322, FIG. 3) updates likes field 530, as shown in FIG. 6, in a metadata structure associated with the media item to reflect the notification. FIG. 5B also illustrates client device 104 detecting a left-to-right swipe gesture with contact 536 on touch screen 506. FIG. 5B also illustrates client device 104 detecting a left-to-right swipe gesture with contact 538 on touch screen 506. FIG. 5B further illustrates client device 104 detecting contact 539 on touch screen 506 (e.g., a press and hold gesture).

In some implementations, advertisements are concurrently displayed with the respective media item such as banner advertisements or advertisements in a side region of the user interface. In some implementations, owners of copyrighted audio tracks and video clips upload at least a sample of the audio tracks and video clips to reference database 344 (FIG. 3) associated with the provider of the application. For example, prior to or while presenting the respective media item, server system 108 or a component thereof (e.g., analyzing module 326, FIG. 3) analyzes the one or more audio files and/or one or more video files associated with the respective media item to generate a digital fingerprint. In some implementations, when server system 108 or a component thereof (e.g., determining module 328, FIG. 3) determines that the digital fingerprint matches copyrighted audio tracks and/or video clips in reference database 344, server system 108 or a component thereof is configured to share advertising revenue with the owners of copyrighted audio tracks and/or video clips.

FIG. 5C illustrates client device 104 continuing to present the respective media item, as in FIG. 5B, and applying an interactive wind effect (e.g., specified in the metadata structure associated with the respective media item) to the one or more media files and the audio track associated with the respective media item in response to detecting the left-to-right swipe gesture with contact 536 in FIG. 5B. In some implementations, one or more characteristics of the swipe gesture, such as the gesture type, number of contacts, direction, acceleration, speed, or distance, determine one or more parameters of the wind effect. In FIG. 5C, the wind effect is applied to the one or more media files associated with the respective media item in a left-to-right direction corresponding to the direction of the swipe gesture in FIG. 5B. In FIG. 5C, the magnitude of the wind effect's impact on the one or more media files is determined by the acceleration or distance of the swipe gesture with contact 536 in FIG. 5B. Furthermore, with reference to FIG. 5C, the wind effect is also applied to the audio track associated with the respective media item in a manner determined by the swipe gesture with contact 536 in FIG. 5B. For example, the magnitude that the wind effect distorts the audio track, or the volume of the wind effect being applied to the audio track, is determined by the acceleration or distance of the swipe gesture with contact 536 in FIG. 5B. FIG. 5C also illustrates client device 104 detecting contact 540 on touch screen 506 at a location corresponding to remix affordance 530.

FIG. 5D illustrates client device 104 continuing to present the respective media item, as in FIG. 5B, and applying an interactive wind effect (e.g., specified in the metadata structure associated with the respective media item) to the one or more media files and the audio track associated with the respective media item in response to detecting the left-to-right swipe gesture with contact 538 in FIG. 5B. In FIG. 5D, the wind effect is applied to the one or more media files associated with the respective media item in a left-to-right direction corresponding to the direction of the swipe gesture with contact 538 in FIG. 5B. In FIG. 5D, the magnitude of the wind effect's impact on the one or more media files is determined by the acceleration or distance of the swipe gesture with contact 538 in FIG. 5B. Furthermore, with reference to FIG. 5D, the wind effect is also applied to the audio track associated with the respective media item in a manner determined by the swipe gesture with contact 538 in FIG. 5B. For example, with respect to FIGS. 5C-5D, the magnitude of the wind effect's impact on the one or more media files and the audio track associated with the respective media item is greater in FIG. 5D than in FIG. 5C because the distance of the swipe gesture with contact 538 in FIG. 5B is greater than the distance of the swipe gesture with contact 536 in FIG. 5B.

FIG. 5E illustrates client device 104 continuing to present the respective media item, as in FIG. 5C, and, also, displaying remix options 560 over the respective media item being presented on touch screen 506 in response to detecting contact 540 selecting remix affordance 530 in FIG. 5C. In FIG. 5E, remix options 560 include: affordance 562 for adding, removing, and/or modifying audio and/or video effect associated with the respective media item; affordance 564 for adding and/or removing one or more video clips associated with the respective media item; and affordance 566 for adding and/or removing one or more audio tracks associated with the respective media item. FIG. 5E also illustrates client device 104 detecting contact 568 at a location corresponding to affordance 566.

For example, after detecting contact 568 selecting affordance 566, in FIG. 5E, to add and/or remove one or more audio tracks associated with the media item presented in FIGS. 5C and 5E, the user of client device selects an audio track from audio library 260 (FIG. 2) or an audio source 124 (FIG. 1) to replace an audio track of the respective media item. In this example, the user of client device 104 selects a cover of the audio track associated with the respective media item to replace the audio track associated with the respective media item (e.g., as specified in the metadata structure associated with the respective media item).

Alternatively, in some implementations, in response to detecting contact 540 selecting remix affordance 530 in FIG. 5C, client device 104 enters a remix mode for editing the respective media item. In the remix mode, client device 104 displays a sequence of representations corresponding to the one or more visual media files and/or audio files comprising the respective media item (e.g., displays a timeline with the visual and audio files). While in the remix mode, the user of client device 104 is able to remove or reorder visual media files and/or audio files of the respective media item by performing one or more gestures with respect to the representations in the sequence of representations. Furthermore, while in the remix mode, the user of client device 104 is able to generate one or more additional video clips, apply different audio and/or video effects, and/or generate an audio track for the respective media item.

FIG. 5F illustrates client device 104 displaying a preview of the modified media item on touch screen 506 that was created from the media item presented to FIGS. 5C and 5E. In FIG. 5F, the user interface includes back navigation affordance 570, which, when activated (e.g., by a touch input from the user), causes client device 104 to display a previous user interface (e.g., the user interface in FIG. 5E), navigation affordance 518, which, when activated (e.g., by a touch input from the user), causes client device 104 to display a navigation panel for navigating between user interfaces of the application (e.g., one or more of a feed view, user profile, user media items, friends view, exploration view, settings, and so on), and creation affordance 520, which, when activated (e.g., by a touch input from the user), causes client device 104 to display a first user interface of a process for generating a media item. In FIG. 5F, the user interface also includes pre-existing hashtags 528 associated with the respective media item and text entry box 574 for adding a comment or hashtag to the modified media item.

In FIG. 5F, the user interface also includes publish affordance 572, which, when activated (e.g., by a touch input from the user), causes client device 104 to cause the modified media item to be published. FIG. 5F also illustrates client device 104 detecting contact 576 at a location corresponding to publish affordance 572. In some implementations, client device 104 causes the modified media item to be published by sending, to server system 108, first information identifying the one or more audio tracks (e.g., the selected cover of the audio track associated with the respective media item) associated with the modified media item, second information identifying one or more media files associated with the modified media item, and third information identifying the one or more audio and/or video effects associated with the modified media item.

FIG. 5G illustrates a client device 104 displaying a family tree user interface on a touch screen 506 (e.g., in response to detecting a contact selecting a publish affordance or family tree affordance). In FIG. 5G, the dotted oval surrounding the node 570-m indicates the currently selected node that corresponds to a current media item. As shown in FIG. 5G, node 570-m has node 570-g as its parent node and it has no child nodes. In some implementations, the family tree user interface shown in FIG. 5G is generated based on media item metadata (e.g., metadata stored in client data 250 or media item metadata database 116).

FIG. 6 is a diagram of representative metadata structure 610 for a media item in accordance with some implementations. For example, in response to receiving information from a client device indicating that a user of the client device has generated a new media item (e.g., the modified media item generated from the media item presented in FIGS. 5C and 5E), server system 108 or a component thereof (e.g., generating module 324, FIG. 3) generates metadata structure 610. In some implementations, the received information at least includes first information identifying one or more audio files for the new media item and second information identifying one or more visual media files (e.g., one or more video clips and/or a sequence of one or more images) for the new media item. In some implementations, the received information also includes third information identifying one or more audio, visual, and/or audiovisual effects associated with the new media item. In some implementations, the metadata structure 610 is stored in media item metadata database 116, as shown in FIGS. 1 and 3, and maintained by server system 108 or a component thereof (e.g., maintaining module 320, FIG. 3).

The metadata structure 610 includes a plurality of entries, fields, and/or tables including a subset or superset of the following:
an identification tag field 612 including a unique identifier for the media item;
an author field 614 including the identifier, name, or handle associated with the creator/author of the media item;
a date/time field 616 including a date and/or time stamp associated with generation of the media item;
one or more visual media file pointer fields 618 including a pointer or link (e.g., a URL) for each of the one or more media files (e.g., one or more video clips and/or a sequence of one or more images) associated with the media item;
one or more audio track pointer fields 620 for each of the one or more audio tracks associated with the media item;
one or more start time fields 621 for each of the one or more audio tracks associated with the media item;
an effects table 622 including an entry 623 for each of zero or more effects to be applied to the media item at run-time upon playback, for example, entry 623-a includes one or more of: the identifier, name, or handle associated with the user who added the effect; the effect type; the effect version; the content (e.g., one or more media files and/or audio tracks) subjected to the effect; a start time (t1) for the effect; an end time (t2) for the effect; one or more preset parameters (p1, p2, . . . ) for the effect; and an effect script or computer-readable instructions for the effect (e.g., GLSL);
an interactive effects table 624 including an entry 625 for each of zero or more interactive audio and/or video effects to be controlled and manipulated at run-time by a subsequent viewer of the media item, for example, the entry 625-a includes one or more of: the identifier, name, or handle associated with the user who added the interactive effect; the interactive effect type; the interactive effect version; the content (e.g., one or more media files and/or audio tracks) subjected to the effect; one or more parameters (p1, p2, . . . ) for the interactive effect; a table mapping interactive input modalities to effect parameters; and an effect script or computer-readable instructions for the interactive effect (e.g., GLSL);
a play count field 626 including zero or more entries 628 for each playback of the media item, for example, entry 628-a includes: the identifier, name, or handle associated with the user who played the media item; the date and time when the media item was played; and the location where the media item was played;
likes field 630 including zero or more entries 632 for each like of the media item, for example, entry 632-a includes: the identifier, name, or handle associated with the user who liked the media item; the date and time when the media item was liked; and the location where the media item was liked;
a shares field 634 including zero or more entries 636 for each share of the media item, for example, entry 636-a includes: the identifier, name, or handle associated with the user who shared the media item; the method by which the media item was shared; the date and time when the media item was shared; and the location where the media item was shared;
a comments field 638 including zero or more entries 640 for each comment (e.g., a hashtag) corresponding to the media item, for example, entry 640-a includes: the comment; the identifier, name, or handle associated with the user who authored the comment; the date and time when the comment was authored; and the location where the comment was authored; and
an associated media items field 642 including zero or more entries 644 for each media item (e.g., a parent or child media item) associated with the media item, for example, entry 644-a corresponding to a parent media item associated with the media item includes: an identification tag for the parent media item; the identifier, name, or handle associated with the user who authored the parent media item; the date and time when the parent media item was authored; and the location where the parent media item was authored.

In some implementations, the metadata structure 610, optionally, stores a subset of the entries, fields, and/or tables identified above. Furthermore, the metadata structure 610, optionally, stores additional entries, fields, and/or tables not described above (e.g., a contributors field identifying each contributor to the media item).

In some implementations, effect parameters include, but are not limited to: (x,y) position and scale of audio and/or video effects, edits, specification of interactive parameters, effect inputs, effect duration, and so on. In some implementations, media item metadata database 116 stores a metadata structure for each media item generated by a user in the community of users associated with the application. In some implementations, each media item is associated with a family tree, and each family tree includes a genesis node corresponding to a root media item (e.g., original media item) and a plurality of leaf nodes corresponding to media items that are modified versions of the root media item. In some implementations, the root media item is a professionally created video (e.g., a music video, film clip, or advertisement) either in “flat” format or in the metadata-annotated format with media items and metadata. In some implementations, the root media item is associated with audio tracks and/or video clips in reference database 344 (FIG. 3). The root media item is automatically determined and is added to the family tree as the genesis node when a digital fingerprint for the one or more audio tracks and one or more video clips corresponding to a respective media item matches the audio tracks and/or video clips in reference database 344 associated with the root media item.

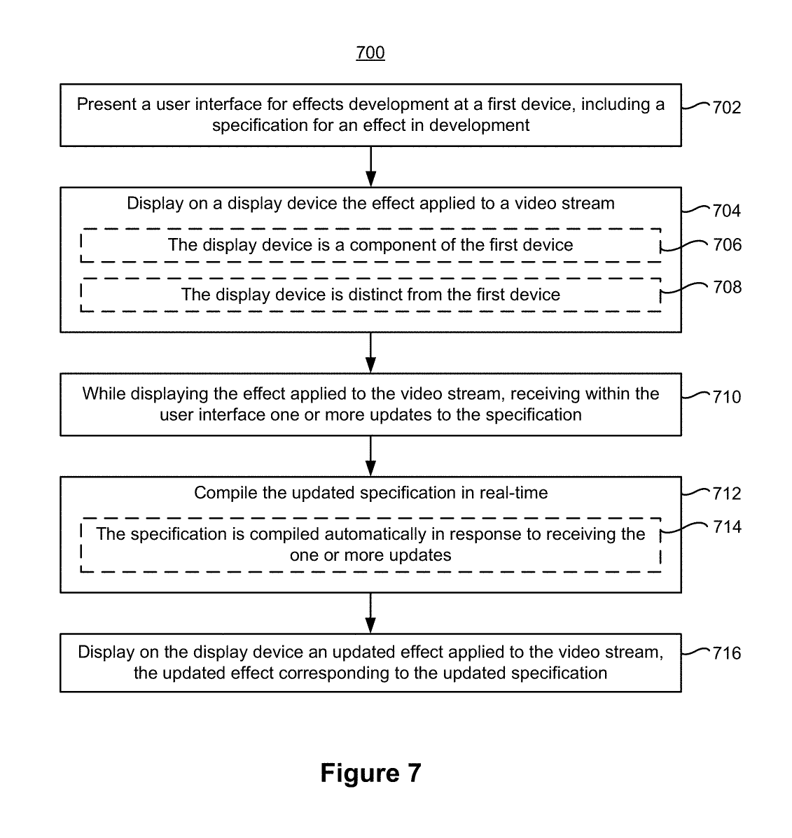

FIG. 7 illustrates a flowchart representation of a method 700 of developing media item effects in accordance with some implementations. In some implementations, the method 700 is performed by: (1) one or more electronic devices, such as the computer system 150 or the client devices 104, FIG. 1; (2) one or more servers, such as one or more servers of server system 108, FIG. 1; or (3) a combination thereof. In some implementations, the method 700 is governed by instructions that are stored in a non-transitory computer-readable storage medium and that are executed by one or more processors of a device/computing system, such as the one or more CPU(s) 202 of the computer system 150 (FIG. 2A) and/or the one or more CPU(s) 122 of the server system 108 (FIG. 3). For convenience, the operations detailed below are described as being performed by a computer system.

The computer system presents (702) a user interface for effects development (e.g., using presentation module 220, FIG. 2A), including a specification for an effect in development (e.g., an effect specification 240 stored in the memory 206). For example, FIG. 4A shows the user interface 401 with the effect specification 402 and the video stream 404. In some implementations, the effect is a shader or filter. In some implementations, the effect modifies a temporal order or speed of at least a portion of the video stream. In some implementations, the effect modifies a geometry of at least a portion of the video stream based at least in part on a predetermined form of geometric. In some implementations, the effect comprises an interactive effect responsive to data from one or more external inputs. In some implementations, the data from the one or more external inputs include at least one of: (1) cursor movement data; (e.g., sensing a user swipe gesture); (2) cursor location data; (e.g., sensing a tap gesture at a particular location); (3) gyroscope data; (e.g., sensing the first device tilting or rotating); (4) accelerometer data; (e.g., sensing the first device moving); (5) audio input data; (e.g., recognizing a beat, word, phrase, or musical composition); (6) visual input data; (e.g., recognizing an object/entity or sensing an amount of color or light in a scene); (7) timing data (e.g., sensing a time of day, time of month, time of year); and (8) location data. (e.g., a GPS location). In some implementations, one or more user-discernable features of the effect are based at least in part on a user profile of the user. For example, the user profile is a user profile gathered based on a user's social media accounts. In some implementations, the computer system includes a graphics processor unit (GPU) and the effect specification is compiled by the GPU. In some implementations, the GPU renders the effect applied to a video stream displayed at the computer system.

The computer system facilitates display (704) on a display device of the effect applied to a video stream (e.g., compiles and renders the effect using presentation module 220 and/or effects application 152, FIG. 2A). For example, FIG. 4A shows the user interface 401 with the effect specification 402 and the video stream 404 having the effect applied to it. In some implementations, the display device is a component (706) of the computer system (e.g., an output device 212, FIG. 2A). In some implementations, the display device is distinct from (708) the computer system (e.g., display device 410, FIG. 4H). In some implementations, the computer system facilitates concurrently displaying a second video stream with the effect applied at a second device, distinct from the computer system and the display device. In some implementations, the video stream comprises an audiovisual stream, and the effect modifies audio output of the audiovisual stream. In some implementations, the video stream comprises a live (e.g., real-time) video stream or a stored video stream.

The computer system, while displaying the effect applied to the video stream, receives (710) within the user interface (e.g., using input processing module 222) one or more updates to the specification (e.g., receives one or more updates via an input device 214, FIG. 2A). For example, FIG. 4B shows an update to the effect specification 402 adjusting a brightness level of the effect.

The computer system compiles (712) the updated specification in real-time (e.g., using effect application 152 in conjunction with CPU(s) 202). In some implementations, the specification is compiled automatically (714) in response to receiving the one or more updates. For example, the computer system receives the updates and compiles the specification without the user needing to initiate the compilation.

The computer system facilitates display (716) on the display device of an updated effect applied to the video stream (e.g., renders the effect using presentation module 220 and/or effects application 152, FIG. 2A), the updated effect corresponding to the updated specification. For example, FIG. 4B shows an update to the effect specification 402 adjusting a brightness level of the effect. FIG. 4B further shows the video stream 404 with the brighter effect applied (compared to the video stream 404 in FIG. 4A).

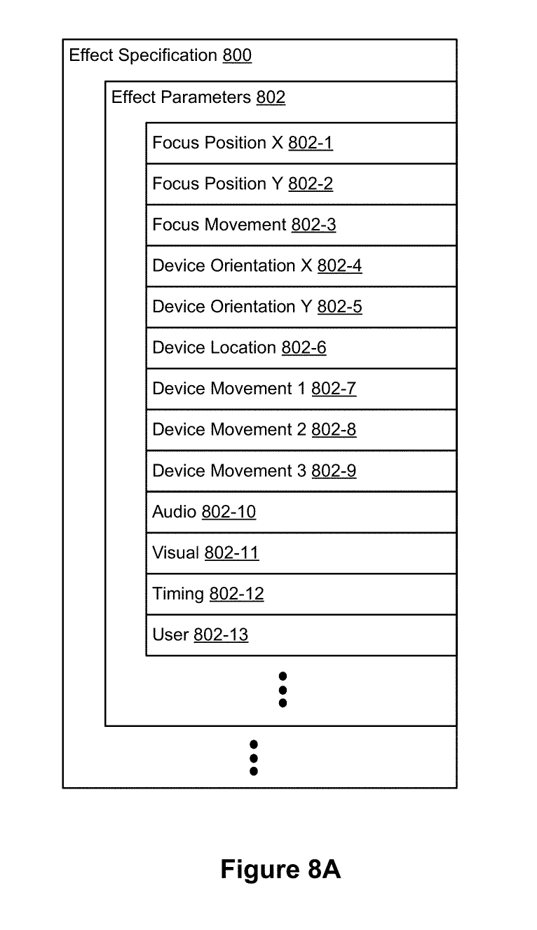

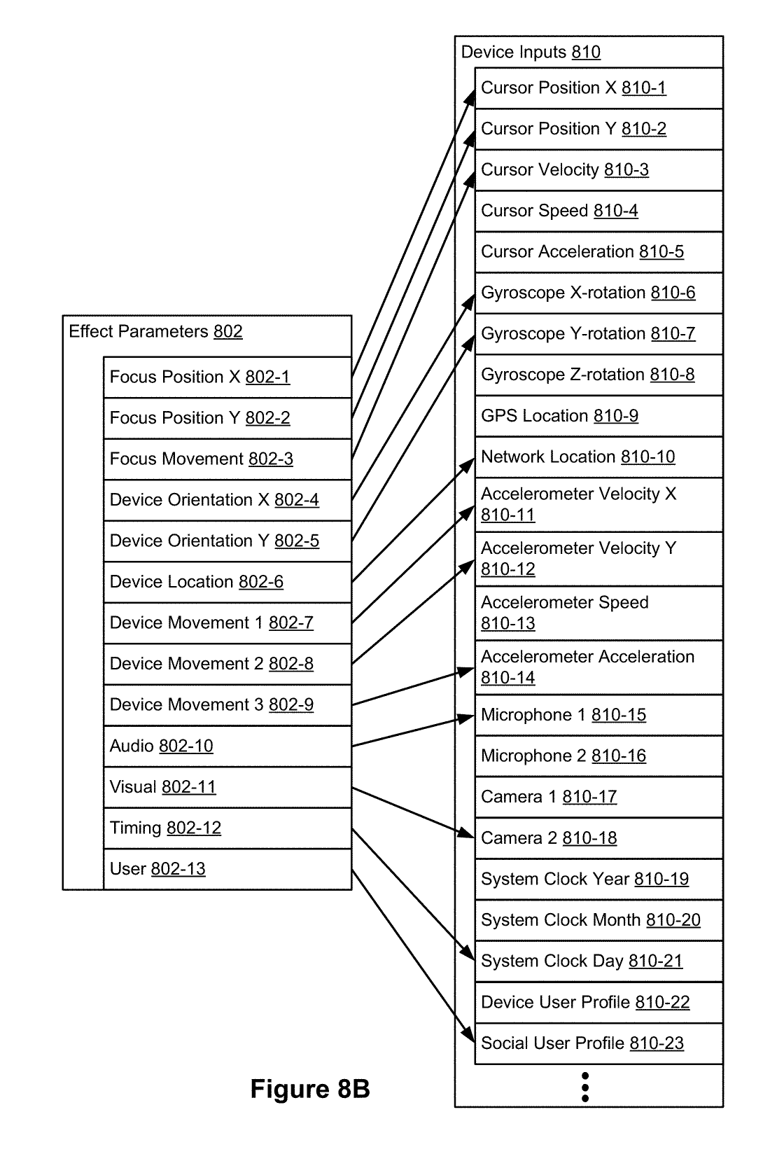

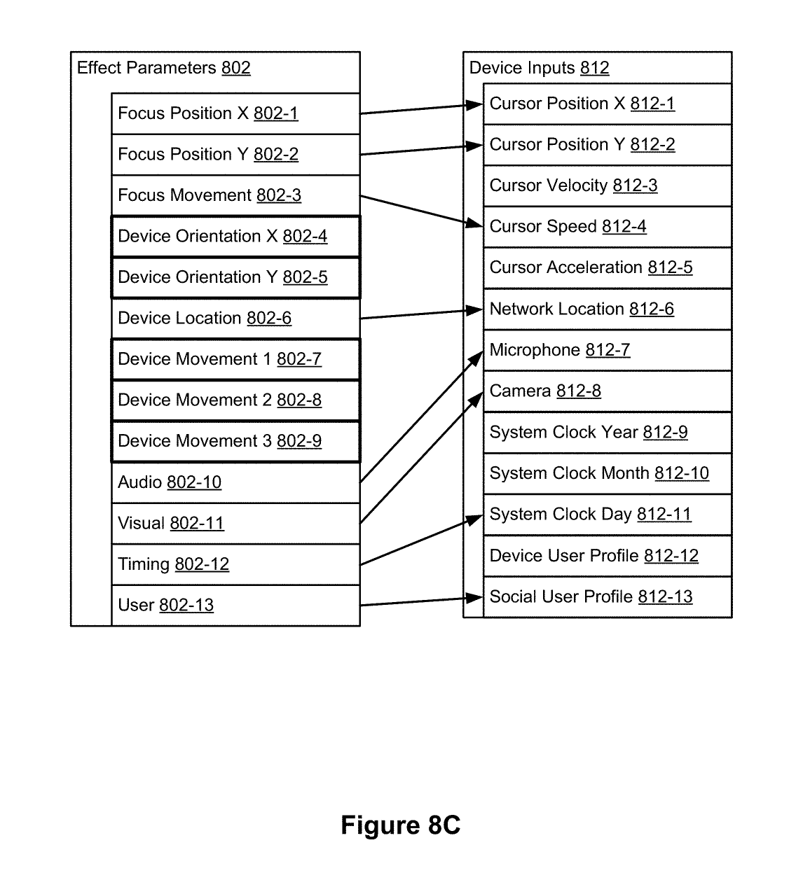

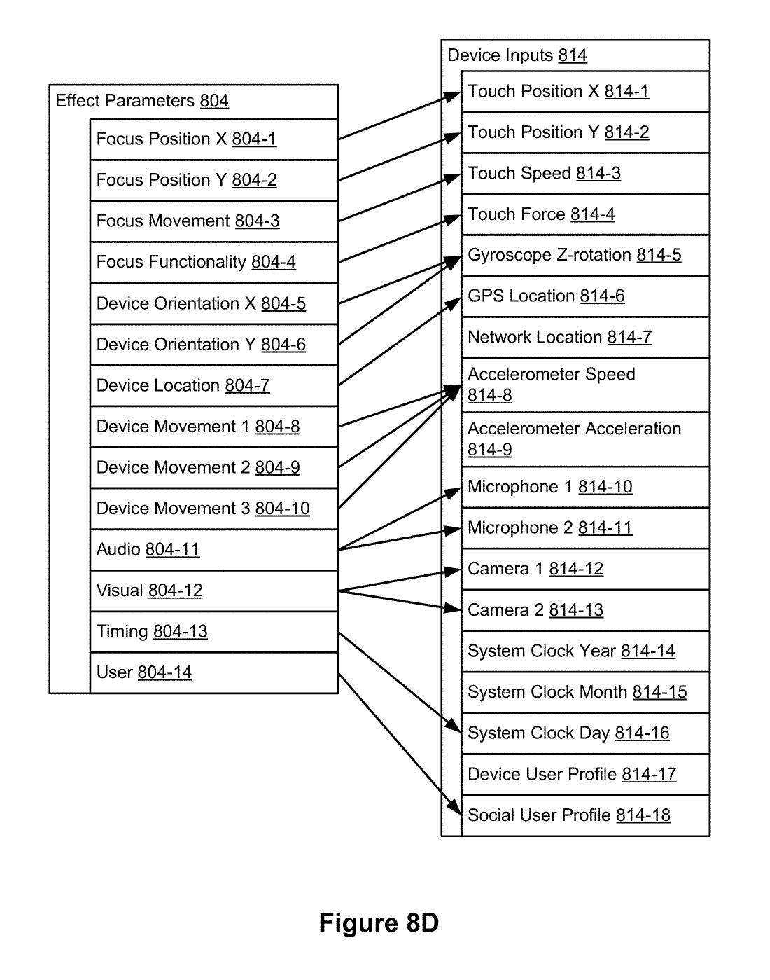

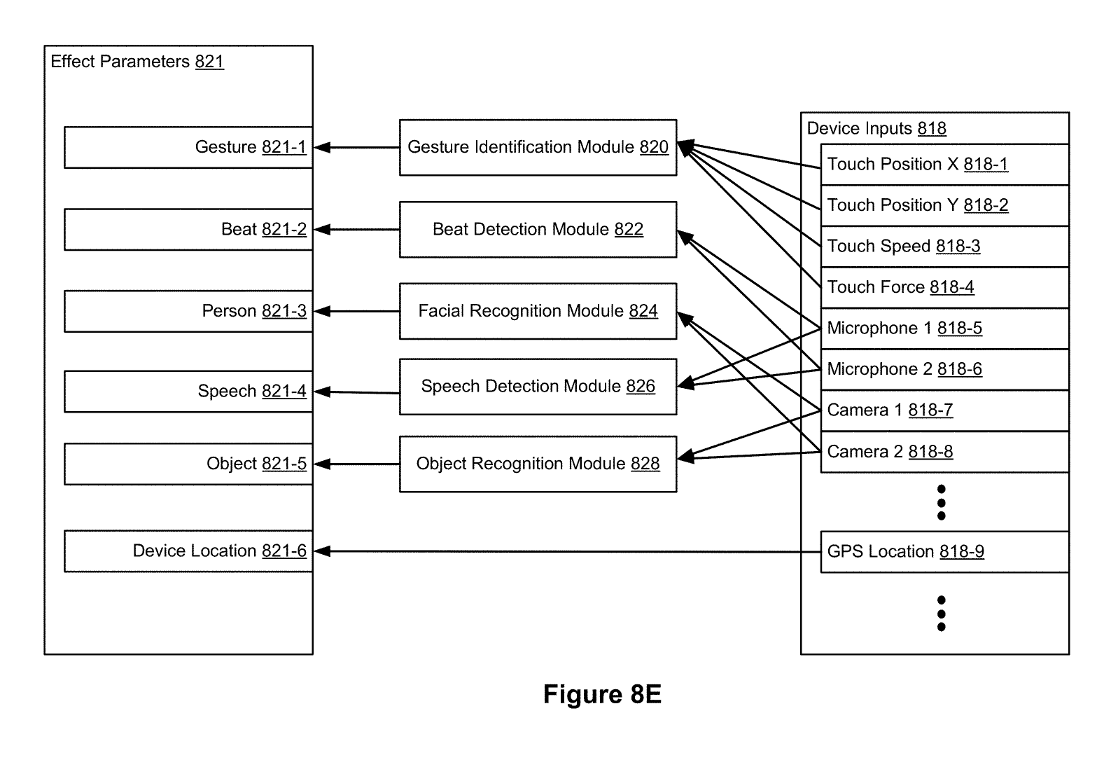

FIG. 8A is a block diagram illustrating representative effect parameters within an effect specification in accordance with some implementations. In FIG. 8A the effect specification 800 includes a plurality of effect parameters 802, including the following parameters, or a subset or superset thereof:
a focus position X parameter 802-1 for varying one or more discernable aspects of the effect based on the location of the focus along the x-axis;
a focus position Y parameter 802-2 for varying one or more discernable aspects of the effect based on the location of the focus along the y-axis;
a focus movement parameter 802-3 for varying one or more discernable aspects of the effect based on movement of the focus (e.g., based on speed or velocity);
a device orientation X parameter 802-4 for varying one or more discernable aspects of the effect based on the device's orientation along the x-axis;
a device orientation Y parameter 802-5 for varying one or more discernable aspects of the effect based on the device's orientation along the y-axis;
a device location parameter 802-6 for varying one or more discernable aspects of the effect based on the device's location (e.g., the device's location on Earth);
device movement parameters 802-7-802-9 for varying one or more discernable aspects of the effect based on movement of the device (e.g., velocity, acceleration, speed, or the like);
an audio parameter 802-10 for varying one or more discernable aspects of the effect based on one or more aspects of an audio input, such as volume, pitch, beat, speech, etc.;
a visual parameter 802-11 for varying one or more discernable aspects of the effect based on one or more aspects of a visual input, such as brightness, contrast, color, recognized objects, recognized persons;
a timing parameter 802-12 for varying one or more discernable aspects of the effect based on one or more aspects of time, such as current year, month, week, day, hour, minute, etc.; and
a user parameter 802-13 for varying one or more discernable aspects of the effect based on one or more aspects of a user, such as user preferences, user characteristics, user history, and the like.

FIGS. 8B-8E illustrate prophetic mappings of effect parameters to device inputs in accordance with some implementations. FIG. 8B shows the effect parameters 802 of FIG. 8A mapped to device inputs 810 of an electronic device (e.g., a client device 104). In the example illustrated by FIG. 8B the device inputs 810 include at least one input corresponding to each effect parameter 802. In some implementations, a particular device input 810 is mapped to a particular effect parameter 802 based on a device profile (e.g., device profile 250, FIG. 2A), a user profile (e.g., user profile 248, FIG. 2A), and/or one or more preferences set within the effects application (e.g., effects application 152, FIG. 1). For example, a device profile for the device inputs 810 optionally specifies that when audio is requested the primary microphone (e.g., microphone 1) is mapped by default in accordance with some implementations. As another example, a user profile for a user of the device having device inputs 810 optionally specifies that the user prefers to map location requests to a network location rather than a GPS location. As another example, the effect application for the effect specification 800 optionally specifies that the focus movement parameter 802-3 should map to cursor velocity (if available) rather than mapping to cursor speed.

In FIG. 8B the effect parameters 802 are mapped as follows:
the focus position X parameter 802-1 is mapped to a cursor position X device input 810-1 (e.g., corresponding to a mouse's position);
the focus position Y parameter 802-2 is mapped to a cursor position Y device input 810-2;
the focus movement parameter 802-3 is mapped to a cursor velocity device input 810-3;
the device orientation X parameter 802-4 is mapped to a gyroscope X-rotation device input 810-6;
the device orientation Y parameter 802-5 is mapped to a gyroscope Y-rotation device input 810-7;
the device location parameter 802-6 is mapped to a network location device input 810-10 (e.g., a location of a coupled LAN or Wi-Fi network obtained by the device);
the device movement parameter 802-7 is mapped to an accelerometer velocity X device input 810-11 (e.g., an accelerometer's measurement of the device's velocity along an x-axis);
the device movement parameter 802-8 is mapped to an accelerometer velocity Y device input 810-12;
the device movement parameter 802-9 is mapped to an accelerometer acceleration device input 810-14;
the audio parameter 802-10 is mapped to a microphone 1 device input 810-15 (e.g., the audio parameter varies based on audio data captured by microphone 1);
the visual parameter 802-11 is mapped to a camera 2 device input 810-18 (e.g., the visual parameter varies based on visual data captured by camera 2);
the timing parameter 802-12 is mapped to a system clock day device input 810-21 (e.g., the timing parameter varies based on the current day specified by the system clock of the device); and
the user parameter 802-13 is mapped to a social user profile device input 810-22 (e.g., the user parameter varies based on one or more aspects of the user's social user profile obtained by the device).

In some implementations and instances, the effect parameters 802 are mapped differently. For example, the focus movement parameter 802-3 is mapped to the cursor speed device input 810-4 in accordance with some implementations and instances. In some implementations, the effect parameters include additional details to enhance accuracy of the mapping (e.g., map the effect parameters to the device inputs in a manner that is intuitive to the effect developer and/or effect users). For example, in some implementations the focus movement parameter 802-3 is a focus velocity parameter or a focus speed parameter; thus indicating whether the directional component of the velocity is desired.

FIG. 8C shows the effect parameters 802 of FIG. 8A mapped to device inputs 812 of an electronic device (e.g., a client device 104). In the example illustrated by FIG. 8C the device inputs 812 do not include at least one input corresponding to each effect parameter 802 (e.g., the device inputs 812 are for a desktop computer that does not have a gyroscope or accelerometer). The device orientation X effect parameter 802-4, device orientation Y effect parameter 802-5, and device movement effect parameters 802-7-802-9 are not mapped to a device input 812 in FIG. 8C in accordance with some implementations and instances. In some implementations, the unmapped effect parameters (e.g., device movement effect parameters 802-7-802-9) are set to a constant value (e.g., a default value specified by the effect application 152). In some implementations, the unmapped effect parameters are disabled in the effect. In some implementations, the unmapped effect parameters are mapped to a default device input that does not correspond to the effect parameters. For example, the device movement effect parameters 802-7-802-9 set to vary with time rather than device movement (e.g., are mapped to system clock device inputs).

FIG. 8D shows effect parameters 804 mapped to device inputs 814 of an electronic device (e.g., a client device 104). In the example illustrated by FIG. 8D the mapping of effect parameters to device inputs is not a one-to-one mapping. The device orientation X and Y effect parameters 804-5 and 804-6 are mapped to a single device input, gyroscope Z-rotation 814-5 (e.g., a two-to-one mapping). In some implementations, in accordance with a determination that the device does not have a device input that directly corresponds to an effect parameter, a related device input is mapped to the effect parameter. For example, the device orientation X effect parameter 804-5 is mapped to the gyroscope Z-rotation device input 814-5 in accordance with a determination that the device inputs 814 do not include an X-rotation input. The device movement effect parameters 804-8-804-10 are mapped to an accelerometer speed device input 814-8 (e.g., a three-to-one mapping). In some implementations, effect parameters mapped to a same device input will vary in a same manner based on data from the device input. For example, device movement effect parameters 804-8-804-10 each vary in a same manner based on device speed data obtained from the accelerometer in accordance with some implementations. In FIG. 8D the audio effect parameter 804-11 is mapped to the microphone 1 device input 814-10 and to the microphone 2 device input 814-11 (e.g., a one-to-two mapping). The audio effect parameter 804-11 varies based on audio data obtained by microphone 1, or microphone 2, or both, in accordance with some implementations. Similarly, the visual effect parameter 804-12 is mapped to the camera 1 device input 814-12 and to the camera 2 device input 814-13 (e.g., a one-to-two mapping). In some implementations and instances the mapping of the effect parameters to the device inputs includes many-to-one and/or one-to-many mappings (e.g., a three-to-one mapping, five-to-one mapping, one-to-five mapping, and the like).

FIG. 8E shows effect parameters 821 mapped to device inputs 818 of an electronic device (e.g., a client device 104). In the example illustrated by FIG. 8E data from some of the device inputs 818 is processed by one or more modules and the output of those modules is mapped to the effect parameters. For example, data from the touch position device inputs 818-1 and 818-2, data from the touch speed device input 818-3, and data from the touch force device input 818-4 is analyzed by a gesture identification module 820 (e.g., to identify touch input gestures). As shown in FIG. 8E:
the touch device inputs 818-1-818-4 are processed by the gesture identification module 820 and an output of the gesture identification module 820 is mapped to the gesture effect parameter 821-1 (e.g., a parameter that varies one or more discernable aspects of the effect in response to recognized gestures);
the microphone device inputs 818-5 and 818-6 are processed by the beat detection module 822 and an output of the beat detection module 822 is mapped to the beat effect parameter 821-2 (e.g., a parameter that varies one or more discernable aspects of the effect in accordance with a beat);
the microphone device inputs 818-5 and 818-6 are also processed by the speech detection module 826 and an output of the speech detection module 826 (e.g., recognized words) is mapped to the speech effect parameter 821-4 (e.g., a parameter that varies one or more discernable aspects of the effect in response to recognized words or phrases);
the camera device inputs 818-7 and 818-8 are processed by the facial recognition module 824 and an output of the facial recognition module 824 (e.g., identification of recognized persons) is mapped to the person effect parameter 821-3 (e.g., a parameter that varies one or more discernable aspects of the effect in response to a recognized person);
the camera device inputs 818-7 and 818-8 are also processed by the object recognition module 828 and an output of the object recognition module 828 (e.g., identification of recognized objects) is mapped to the object effect parameter 821-5 (e.g., a parameter that varies one or more discernable aspects of the effect in response to recognized objects); and
the GPS location device input 818-9 is mapped to the device location effect parameter 821-6.

In some implementations, at least one of the modules 820, 822, 824, 826, and 828 is a component of the effects application (e.g., effects application 152). For example, the effects application obtains data from the touch device inputs 818-1-818-4 and processes the data to identify touch gestures. In some implementations, at least one of the modules 820, 822, 824, 826, and 828 resides on the electronic device (e.g., the client device 104). For example, the application(s) 223 (FIG. 2A) include one or more of the modules 820, 822, 824, 826, and 828. In some implementations, at least one of the modules 820, 822, 824, 826, and 828 resides on a server (e.g., a server of server system 108). For example, the application(s) 313 (FIG. 3) include one or more of the modules 820, 822, 824, 826, and 828. For example, visual data from the camera device inputs 818-7 and 818-8 is transmitted to a server of server system 108. In this example, the server system 108 performs object recognition on the visual data and transmits information regarding any recognized objects to the electronic device. In this example, the transmitted information is mapped to the object effect parameter 821-5.

In some implementations, a single device input is processed by an analyzing module and an output of the analyzing module is mapped to an effect parameter. For example, the device inputs 818 include a single device location input (e.g., GPS location device input 818-9) and a city identification module analyzes data from the single device location input to identify a closest city for the electronic device. The identified city in this example is mapped to a city effect parameter (e.g., a parameter that varies one or more discernable aspects of the effect in accordance with the identified city).

In some implementations, a particular device input 818 (e.g., touch force 818-3) is mapped to an effect parameter (e.g., a focus functionality effect parameter) and is used as an input to an analyzing module (e.g., a gesture identification module) whose output is mapped to a different effect parameter (e.g., a gesture parameter). In some implementations, output from a single module maps to multiple effect parameters. For example, an audio processing module analyzes audio data from one or more microphones of the device and outputs beat data identifying any beats in the audio data and speech data identifying any recognized speech in the audio data. In this example, the beat data output is mapped to a beat effect parameter and the speech data is mapped to a speech effect parameter.

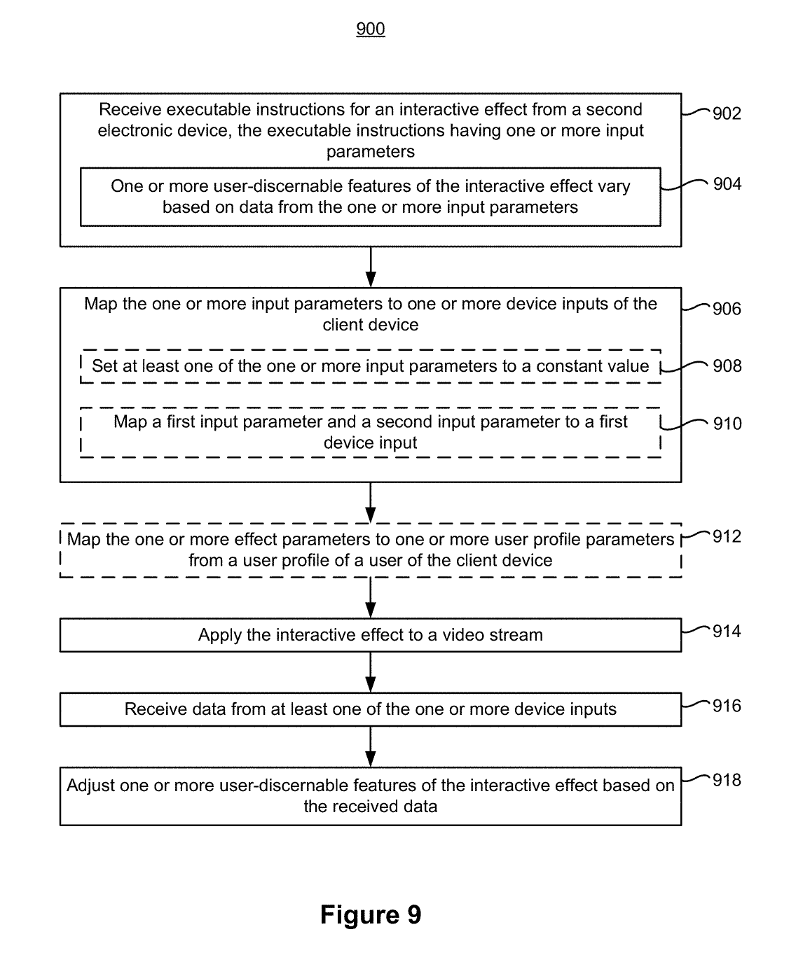

FIG. 9 illustrates a flowchart representation of a method 900 of providing interactive effects in accordance with some implementations. In some implementations, the method 900 is performed by: (1) one or more electronic devices, such as the computer system 150 or client devices 104, FIG. 1; (2) one or more servers, such as one or more servers of server system 108, FIG. 1; or (3) a combination thereof. In some implementations, the method 900 is governed by instructions that are stored in a non-transitory computer-readable storage medium and that are executed by one or more processors of a device/computing system, such as the one or more CPU(s) 202 of client device 104 (FIG. 2A) and/or the one or more CPU(s) 122 of server system 108 (FIG. 3). For convenience, the operations detailed below are described as being performed by a client device.

The client device receives (902) executable instructions for an interactive effect from a second electronic device (e.g., receives the instructions via network interface(s) 254 and network communications module 268), the executable instructions having one or more input parameters. For example, the client device 102-1 receives the instructions from the computer system 150 in FIG. 1. In some implementations, the executable instructions include an effect specification, such as effect specification 402 (FIGS. 4A-4E) or effect specification 800 (FIG. 8A). In some implementations, the one or more input parameters include one or more of the effect parameters 802 (FIG. 8A).

One or more user-discernable features of the interactive effect vary (904) based on data from the one or more input parameters. For example, in FIG. 4E a split in color in the effect varies based on a position of the cursor 408 along a y-axis. As another example, in FIGS. 4F-4G a distortion effect varies based on a position of the touch input 412 along an x-axis. In some implementations, one or more audio components of an effect vary based on data from one or more of the input parameters. For example, a static noise effect increase in amplitude based on an acceleration of the device (e.g., shaking the device causes the effect to generate a static noise effect).

The client device maps (906) the one or more input parameters to one or more device inputs of the client device (e.g., using input mapping module 232, FIG. 2A). For example, FIG. 8B shows a mapping of effect parameters 802 to a subset of device inputs 810. In some implementations, the mapping is based at least in part on an operating system of the client device. For example, the client device's operating system denotes a particular microphone as a default microphone and the default microphone is mapped to an audio effect parameter. In some implementations, the mapping is based at least in part on a device type of the client device. For example, a first device type supports concurrently obtaining data from multiple cameras and maps a visual effect parameter to each of the cameras (a one-to-many mapping). In this example, a second deice type does not support concurrently obtaining data from multiple cameras and maps the visual effect parameter to a single camera of the device (a one-to-one mapping). In some implementations, the mapping is based at least in part on a device profile. For example, the device profile specifies whether a GPS location or a network location is preferred and maps the preferred location to a location effect parameter. In some implementations, the mapping is based at least in part on a user profile. For example, the user profile specifies that a user prefers to be affiliated with the user's undergraduate university rather than the user's graduate university and maps the undergraduate university to a school effect parameter (e.g., a parameter that varies one or more colors within an effect based on the mapped school's colors). In some implementations, the mapping is based at least in part on the set of device inputs for the client device. For example, a client device having a GPS location, but not a network location, maps the GPS location to a location effect parameter.

In some implementations, the client device sets (908) at least one of the one or more input parameters to a constant value. For example, a desktop computer lacking a gyroscope (or other means of determining an orientation of the computer) sets an orientation parameter to a constant value in accordance with some implementations. FIG. 8C shows a mapping where device orientation effect parameters 802-4 and 802-5 and device movement parameters 802-7-802-9 are unmapped. In accordance with some implementations, these parameters are set to constant values as a result of being unmapped. In some implementations, in accordance with a determination that an effect input parameter does not map to any device input, the client device maps the effect input parameter to a default device input, such as current time.

In some implementations, the client device maps (910) a first input parameter and a second input parameter to a first device input. For example, the client device maps an effect input parameter for device speed and an effect input parameter for device movement direction both to a device velocity input (e.g., a velocity input calculated by an accelerometer of the device). FIG. 8D shows device orientation X effect parameter 804-5 and device orientation Y effect parameter 804-6 mapped to gyroscope Z-rotation device input 814-5 in accordance with some implementations. In some implementations, a first device input and a second device input are mapped to a single effect parameter. For example, FIG. 8D shows camera 1 device input 814-12 and camera 2 device input 814-13 mapped to visual effect parameter 804-12.

In some implementations, the client device maps (912) the one or more effect parameters to one or more user profile parameters from a user profile of a user of the client device. In some implementations, the executable instructions for the interactive effect have one or more effect parameters. In some implementations, the client device: (1) maps the one or more effect parameters to one or more user profile parameters from a user profile of a user of the client device; and (2) adjusts one or more user-discernable features of the interactive effect based on the one or more user profile parameters. In some implementations, applying the interactive effect includes applying the adjusted one or more user-discernable features. For example, an interactive effect specifies that a particular color within the effect is based on a user's school colors. In this example, users from one school see the effect with different colors than users from another school. As another example, an effect includes an effect parameter that varies one or more discernable features of the effect based on a user's preferences (e.g., color preferences, music genre preferences, etc.), a parameter that varies one or more discernable features based on a user's biography (e.g., a user's school colors, hometown, etc.), and/or a parameter that varies one or more discernable features based on a user's prior selections (e.g., prior effect selections, media item selections, parameter selections, etc.).

The client device applies (914) the interactive effect to a video stream. For example the client device applies the interactive effect to a live or stored video stream displayed by the client device. In some implementations, the client device compiles the interactive effect and renders the interactive effect applied to the video stream. In some implementations, the received effect is associated with a particular video stream and the client applies the interactive effect to the video stream automatically when the video stream is displayed (e.g., applies the interactive effect without explicit instructions from a user of the client device). In some implementations, the effect is applied to an audiovisual media item.

The client device receives (916) data from at least one of the one or more device inputs (e.g., using input processing module 272, FIG. 2B). The client device adjusts (918) one or more user-discernable features of the interactive effect based on the received data (e.g., using effects module 288, FIG. 2B). For example, a client device has mapped a focus position parameter to a cursor position device input. In this example, the client device detects movement of the cursor to a new position and adjusts the interactive effect based on the new cursor position. For example, FIGS. 4F-4G show the touch input 412 moving from position 412-a in FIG. 4F to position 412-b in FIG. 4G. FIGS. 4F-4G further show a distortion of the video increasing in response to the touch input 412 moving to position 412-b. As another example, FIG. 4H shows a client device 104 mapping a focus input parameter to a cursor position 418 and adjusting a pixilation of the video stream 415 based on the cursor position 418. FIG. 4H further shows a display device 410 mapping the focus input parameter to a touch position 420 and adjusting a pixilation of the video stream 416 based on the touch position 420.

For situations in which the systems discussed above collect information about users, the users may be provided with an opportunity to opt in/out of programs or features that may collect personal information (e.g., information about a user's preferences or usage of a smart device). In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

It will be understood that, although the terms “first,” “second,” etc. may be used herein to describe various elements, these elements should not be limited by these terms. These terms are only used to distinguish one element from another. For example, a first touch input could be termed a second touch input, and, similarly, a second touch input could be termed a first touch input, without changing the meaning of the description, so long as all occurrences of the “first touch input” are renamed consistently and all occurrences of the “second touch input” are renamed consistently. The first touch input and the second touch input are both touch inputs, but they are not the same touch input.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the claims to the precise forms disclosed. Many modifications and variations are possible in view of the above teachings. The implementations were chosen and described in order to best explain principles of operation and practical applications, to thereby enable others skilled in the art.

What is claimed is:

1. A method, comprising:
at a first device having one or more processors and memory:
presenting a user interface for effects development, including a specification for an effect in development;
displaying on a display device the effect applied to a video stream;
while displaying the effect applied to the video stream, receiving within the user interface one or more updates to the specification;
compiling the updated specification in real-time; and
displaying on the display device an updated effect applied to the video stream, the updated effect corresponding to the updated specification.
